(19) United States
(12) Patent Application Publication
(10) Pub. No.: US 2007/0292681 A1
(43) Pub. Date: Dec. 20, 2007

(54) Organic electroluminescence device

(75) Inventors: Daisuke Okuda, Kanagawa (JP); Toru Ishii, Kanagawa (JP); Hirohito Yoneyama, Kanagawa (JP); Yohei Nishino, Kanagawa (JP); Akira Imai, Kanagawa (JP); Tadayoshi Ozaki, Kanagawa (JP); Hidekazu Hirose, Kanagawa (JP); Mieko Seki, Kanagawa (JP); Koji Horiba, Kanagawa (JP); Takeshi Agata, Kanagawa (JP); Kiyokazu Mashimo, Kanagawa (JP); Katsuhiro Sato, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD, TOKYO (JP)

(21) Appl. No.: 11/594,943

(22) Filed: Nov. 9, 2006

(30) Foreign Application Priority Data
Jun. 20, 2006 (JP) 2006-170482
Jun. 20, 2006 (JP) 2006-170483

(51) Int. Cl. B32B 27/36

(52) U.S. Cl. 428/336; 428/480

(57) ABSTRACT

An organic electroluminescence device of the invention includes: an anode; a cathode; and an organic compound layer; the organic compound layer including at least one layer including a charge-transporting polyester; the charge-transporting polyester including repeating units each containing a structure represented by the following formula (I-1) or (I-2); the thickness being about 20 to 100 nm of the nearest layer to the anode of the at least one layer including the charge-transporting polyester; the cathode including a first layer and a second layer; the first layer being in contact with the organic compound layer and including an alkaline metal oxide, alkaline earth metal oxide, alkaline metal halide or alkaline earth metal halide; the second layer being in contact with the first layer and including an alkaline metal or alkaline earth metal.

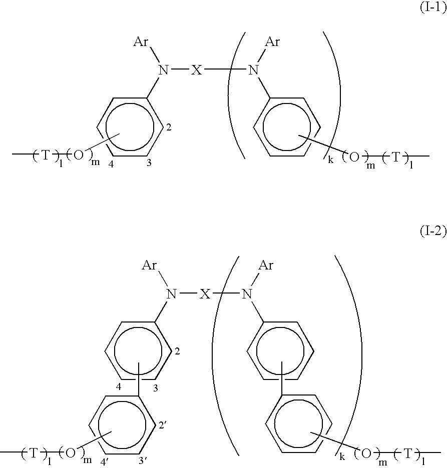

### BACKGROUND

1. Technical Field

The present invention relates to an organic electroluminescence device.

2. Related Art

An electroluminescence device is a totally solid-state self-emitting device, and is expected to be used for wide applications because of its high visibility and high impact resistance. Currently devices utilizing inorganic fluorescent materials are principally used, but these have the problems that a high AC driving voltage of 200 V or higher is required, production cost is high and they show insufficient brightness.

### SUMMARY

According to an aspect of the invention, there is provided an organic electroluminescence device comprising: an anode; a cathode; and an organic compound layer, sandwiched between the anode and the cathode;

at least one of the anode or the cathode being transparent or semi-transparent;

the organic compound layer including one or more layers including at least a light-emitting layer;

the organic compound layer including at least one layer including at least one charge-transporting polyester;

the charge-transporting polyester including repeating units each containing, as a partial structure, one or more structures each represented by the following formula (I-1) or (I-2):

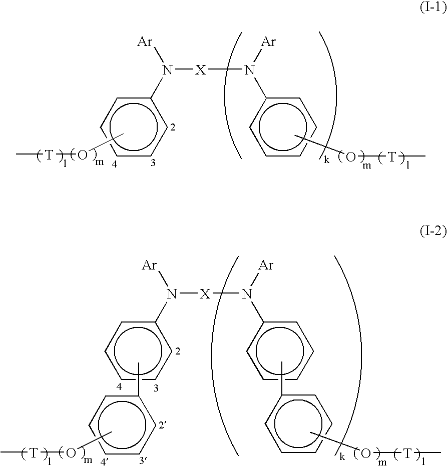

in the formulas (I-1) and (I-2), Ar representing a substituted or unsubstituted monovalent aromatic group, X representing a substituted or unsubstituted divalent aromatic group, k, m and l each representing 0 or 1, and T representing a linear divalent hydrocarbon having 1 to 6 carbon atoms or a branched hydrocarbon having 2 to 10 carbon atoms;

the thickness being about 20 to 100 nm of the nearest layer to the anode of the at least one layer including at least one charge-transporting polyester;

the cathode comprising a first layer and a second layer;

the first layer being in contact with the organic compound layer and comprising at least one selected from the group consisting of alkaline metal oxides, alkaline earth metal oxides, alkaline metal halides and alkaline earth metal halides;

the second layer being in contact with the first layer and comprising at least one selected from the group consisting of alkaline metals and alkaline earth metals.

### BRIEF DESCRIPTION OF THE DRAWINGS

Exemplary embodiments of the present invention will be described in detail based on the following figures, wherein:

FIG. 1 is a schematic cross-sectional view showing an example of a layered structure of an organic electroluminescence device of the present invention;

FIG. 2 is a schematic cross-sectional view showing an example of a layered structure of an organic electroluminescence device of the present invention;

FIG. 3 is a schematic cross-sectional view showing an example of a layered structure of an organic electroluminescence device of the present invention;

FIG. 4 is a schematic cross-sectional view showing an example of a layered structure of an organic electroluminescence device of the present invention;

FIG. 5 is a schematic cross-sectional view showing an example of a layered structure of an organic electroluminescence device of the present invention; and

FIG. 6 is a schematic cross-sectional view showing an example of a layered structure of an organic electroluminescence device of the present invention.

### DETAILED DESCRIPTION

Research into electroluminescence devices utilizing organic compounds started utilizing single crystals such as of anthracene, but such a single crystals have a thickness as large as about 1 mm and required a driving voltage of 100 V or higher. For this reason, thin film formations have been tried using vapor deposition methods (see. Thin Solid Films, Vol. 94, 171(1982)).

However, thin films obtained by such a method still required a driving voltage as high as 30 V, and have a low density of electron and hole carriers in the film, thus since there is a low probability of photon generation by recombination of carriers, they are incapable of providing sufficient brightness.

It was however recently reported that, in an electroluminescence device of function-separated type, formed by sequentially laminating thin films of an organic low-molecular compound having a hole transporting ability and a fluorescent organic low-molecular compound having an electron transporting ability by a vacuum deposition method, a high brightness of 1000 cd/m² or higher could be obtained by a low voltage of about 10 V (see. Applied Physics Letters, Vol. 51, 913(1987)). Since this report, electroluminescence devices of laminated type have been actively developed.

In such a laminate-type device, holes and electrons are injected from electrodes through charge transport layers of charge-transporting organic compounds, while maintaining a carrier balance between the holes and the electrons, into a light-emitting layer of a fluorescent organic compound, and the holes and the electrons confined in the light-emitting layer recombine to realize light emission of high brightness.

However, the electroluminescence device of this type involves the following problems for commercialization.

(1) As it is driven with a high current density of several mA/cm², a large amount of Joule heat is generated. Therefore, the hole-transporting low-molecular compound and the fluorescent organic low-molecular compound, which are formed in thin films of an amorphous glass state by vapor deposition, gradually crystallize and finally melt to often result in a loss of brightness or a dielectric breakdown, thereby decreasing the life of the device.

(2) As thin films of 0.1 μm or less of organic low-molecular compounds are formed in plural vapor deposition steps, pinholes tend to be generated, and film thickness control under strictly managed conditions is essential for obtaining sufficient performance. Therefore, productivity is low and increasing the area of devices is difficult.

For the purpose of solving the above-mentioned problem (1), there are reported electroluminescence devices utilizing a star-burst amine capable of providing a stable amorphous glass state as a hole-transporting material (for example see 40th Japanese Society for Applied Physics (JSAP) and Related Societies Meeting, preprint 30a-SZK-14(1993)), and electroluminescence devices employing a polymer in which triphenylamine is introduced in a side chain of polyphosphazene (see 42nd Society for Polymer Science Japan Polymer Conference preprint 20J21(1993)).

However, such materials, when employed singly, are unable to provide a satisfactory hole-injecting property from an anode or into a light-emitting layer because of the presence of an energy barrier resulting from an ionization potential of the hole transporting material. Also the former star burst amine has the problem that it is difficult to improve purity because of the low solubility, while the latter polymer has the problem of being unable to provide sufficient brightness because of insufficient current density.

Also, for solving the above-mentioned problem (2), research and development has been made for an organic electroluminescence device of a single layer structure for simplifying the processes, and there have been reported a device utilizing a conductive polymer such as poly(p-phenylenevinylene) (for example see Nature, Vol. 357, 477(1992)) and a device in which an electron transporting material and a fluorescent dye are mixed in a hole-transporting polyvinylcarbazole (see 38th JSAP and Related Societies Meeting, preprint 31p-g-12 (1991)), but such devices are still inferior, in brightness and light-emitting efficiency, to the laminate type organic electroluminescence device utilizing organic low-molecular compounds.

Also, from the view point of the manufacturing process, a wet coating process has been studied for the purpose of achieving simpler manufacture, better processability, larger area, a lower cost and so forth, and it has been reported that devices can be obtained by a casting process (50th JSAP Meeting, preprint 29p-ZP-5 (1989), and 51 st JSAP Meeting, preprint 28a-PB-7 (1990)). However, such devices have problems with manufacturing or their characteristics because the charge-transporting material tends to crystallize as it is poor in solubility in solvent or compatibility with a resin.

Also, since a display device utilizing an organic electroluminescence device is more suitable for realizing a compact and thin structure in comparison with other display devices such as liquid crystal display devices, it is expected to be used as a portable device driven by an internal power source. For realizing such a portable device, it is important that the device can be driven for a long time with lower electric power consumption.

On the other hand, an organic electroluminescence device has a basic layer structure having a hole transport layer (or a light-emitting layer having a charge-transporting function) on an ITO transparent electrode (anode), with other layers as necessary. For adaptating to the aforementioned application and giving further energy savings, there is known a method of providing a buffer layer between the transparent electrode and the hole transport layer (or the light-emitting layer having a charge-transporting function) to improve the charge (hole) injection efficiency into the hole transport layer (or the light-emitting layer having a charge-transporting function), thereby reducing the driving voltage. Such a buffer layer is typically composed, for example, of PEDOT (polyethylene dioxythiophene), a star burst amine, or CuPc (copper phthalocyanine).

Such a buffer layer can certainly reduce the driving voltage. However, in the practical applications such as manufacture of organic electroluminescence devices having a buffer layer and prolonged use of a device utilizing such electroluminescence devices, it has been found that various problems occur in manufacture leading to low yield and deterioration of the device performance occurs with time, so that such a device is often unsuitable for practical use.

### <Organic Electroluminescence Device According to the First Aspect of the Invention>

The organic electroluminescence device according to the first aspect of the invention is an organic electroluminescence device comprising: an anode; a cathode; and an organic compound layer, sandwiched between the anode and the cathode;

at least one of the anode or the cathode being transparent or semi-transparent;

the organic compound layer including one or more layers including at least a light-emitting layer;

the organic compound layer including at least one layer including at least one charge-transporting polyester;

the charge-transporting polyester including repeating units each containing, as a partial structure, one or more structures each represented by the following formula (I-1) or (I-2):

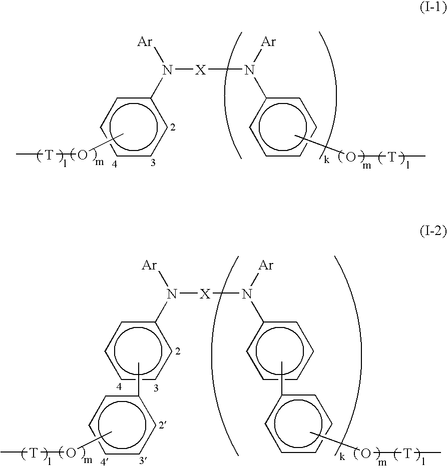

in the formulas (I-1) and (I-2), Ar representing a substituted or unsubstituted monovalent aromatic group, X representing a substituted or unsubstituted divalent aromatic group, k, m and l each representing 0 or 1, and T representing a linear divalent hydrocarbon having 1 to 6 carbon atoms or a branched hydrocarbon having 2 to 10 carbon atoms;

the thickness being about 20 to 100 nm of the nearest layer to the anode of the at least one layer including at least one charge-transporting polyester;

the cathode comprising a first layer and a second layer;

the first layer being in contact with the organic compound layer and comprising at least one selected from the group consisting of alkaline metal oxides, alkaline earth metal oxides, alkaline metal halides and alkaline earth metal halides;

the second layer being in contact with the first layer and comprising at least one selected from the group consisting of alkaline metals and alkaline earth metals.

The organic electroluminescence device according to the first aspect of the invention, owing to the above configuration, has sufficient brightness, is superior in stability and durability, can be formed over a large area, is easily manufactured, and shows few defects caused in the manufacture and little deterioration in the device performance with time. This is thought to be because of the following reasons.

It is important to use materials having a highly flexible molecular structure and high heat resistance, from the view points of providing a charge-injecting property, charge mobility and thin film formability, preferable characteristics for an organic electroluminescence device, being able to form by a wet coating process, manufacturability, and giving the durability that enables long time use in practice.

With respect to deteriorations in device performances with time, from the view point of improving the charge-injecting efficiency to lower the driving voltage, kinds and compositions of electrode (cathode) materials of metals, metal alloys or metal compounds have been extensively studied. As a result, it has been found that the use of, in place of a single kind of metal conventionally used, alloys composed of alkaline metals and alkaline earth metals such as lithium, magnesium and calcium, which have a low work function, improves the charge (electron) injecting efficiency.

However, in fact, it has been found that diffusion of lithium, calcium or the like to the organic compound layer side with time causes deterioration of the device, whereby the life of the device is not actually improved. Then, it has been found that, for maintaining the electron-injecting property and preventing the diffusion, a thin film of a metal compound such as alkaline metal oxides, alkaline earth metal oxides, alkaline metal halides and alkaline earth metal halides provided as an insulating layer between the organic compound layer and the cathode lower the driving voltage and improve the life of the device.

The present inventors have found that, when the above-mentioned charge-transporting polyester is used in the organic compound layer, effectiveness in prolonging the life of the device by providing a thin layer containing an alkaline metal oxide, alkaline earth metal oxide, alkaline metal halide or alkaline earth metal halide, for preventing diffusion of the metal used in the cathode into the organic compound layer, is even higher than when other charge-transporting materials are used.

In addition, in order to further lower the driving voltage of the device for practical use, the present inventors have studied the kinds and compositions of cathode materials that have good compatibility with the charge-transporting polyester having a highly flexible molecular structure and high heat resistance and that further improve the properties of the device using the charge-transporting polyester. Further, the present inventors have studied the thickness of the layer that contains the charge-transporting polyester and is nearest to the anode. As a result, the first aspect of the present invention has been found.

That is, in the first aspect of the invention, the charge-transporting polyester that has sufficient charge mobility, a flexible and dense molecular structure, and high heat resistance is used to provide a sufficient brightness and improve the stability and durability. Further, in addition to the use of such an organic compound layer, by configuring the cathode so as to include a metal layer (second layer) of a specific metal element and a specific alkaline compound layer (first layer) for preventing the diffusion from the metal layer to the organic compound layer, the driving voltage can be lowered, so that the electric power consumption is suppressed as compared to a conventional device. This effect is significantly higher than in the case of using an organic compound layer containing other charge-transporting materials. That is, effectiveness in prolonging the life is significantly higher than in the case of using an organic compound layer containing other charge-transporting materials.

In addition, when the thickness of the charge-transporting polyester-containing layer that is nearest to the anode is in the specific range, the charge-injecting property, the charge-transporting property and the charge balance are improved, thereby providing a high stability, high brightness and high efficiency, so that the life of the device and the light emitting brightness are further improved.

Further, in the manufacturing process of the device, when all the materials of the organic compound layer are polymer compounds, the organic compound layer can be formed by wet coating processes alone, which provides advantages in simplification of manufacturing, workability, formation over a large area and costs. However, the charge-transporting polyester in the first aspect of the invention can realize stable device characteristics, regardless of the kind of the light-emitting materials used in the light-emitting layer.

### <Organic Electroluminescence Device According to the Second Aspect of the Invention>

The organic electroluminescence device according to the second aspect of the invention is an organic electroluminescence device comprising: an anode; a cathode; and an organic compound layer, sandwiched between the anode and the cathode;

at least one of the anode or the cathode being transparent or semi-transparent;

the organic compound layer including two or more layers including at least a light-emitting layer and a buffer layer;

the organic compound layer including at least one layer containing at least one charge-transporting polyester;

the charge-transporting polyester including repeating units each containing, as a partial structure, one or more structures each represented by the following formula (I-1) or (I-2):

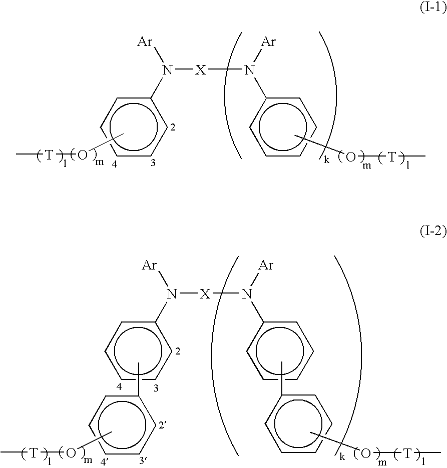

in the formulas (I-1) and (I-2), Ar representing a substituted or unsubstituted monovalent aromatic group, X representing a substituted or unsubstituted divalent aromatic group, k, m and l each representing 0 or 1, and T representing a linear divalent hydrocarbon having 1 to 6 carbon atoms or a branched hydrocarbon having 2 to 10 carbon atoms;

the thickness being about 20 to 100 nm of the nearest layer to the anode of the at least one layer including at least one charge-transporting polyester;

the cathode comprising a first layer and a second layer;

the first layer being in contact with the organic compound layer and comprising at least one selected from the group consisting of alkaline metal oxides, alkaline earth metal oxides, alkaline metal halides and alkaline earth metal halides;

the second layer being in contact with the first layer and comprising at least one selected from the group consisting of alkaline metals and alkaline earth metals;

the buffer layer being provided in contact with the anode and including one or more charge-injecting materials;

at least one of the charge injecting materials being a charge-transporting polymer including a structural unit represented by the following formula (II):

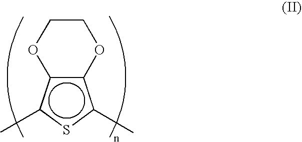

in the formula (II), n representing an integer of from 100 to 10,000.

The organic electroluminescence device according to the second aspect of the invention, owing to the above configuration, has sufficient brightness, is superior in stability and durability, can be formed over a large area, is easily manufactured, and shows few defects caused in manufacture and little deterioration in the device performance with time. This is thought to be because of the following reasons.

The present inventors have studied the factors that cause the various problems in manufacturing and the deterioration in the device performance with time when manufacturing an organic electroluminescence device having a buffer layer. And, the present inventors have studied the problems caused when forming, on a surface of a buffer layer formed on an anode, a hole transport layer or a light-emitting layer having a charge-transporting ability (hereinafter, a layer formed directly on the buffer layer or indirectly with another layer therebetween may be abbreviated as an “adjacent layer”) using a polymer-based charge-transporting material.

As a result, it has been found that when the charge-transporting polymer to be used has a vinyl skeleton (for example PTPDMA (see Polymer Reports, Vol. 52, 216(1995)) or a polycarbonate skeleton (for example Et-TPAPEK (see 43rd JSAP and Related Societies Meeting preprints 27a-SY-19, pp. 1126(1996))), insufficient adhesion between the buffer layer and the adjacent layer may cause peeling defects, pinholes or aggregations. Such defects are thought to result from a poor affinity of the buffer layer and the adjacent layer at the interface, and lack of flexibility of the polymer constituting the adjacent layer.

Accordingly, it is thought that such defects at the film formation may be avoided by improving the flexibility of the molecule or facilitating the intermolecular re-arrangement in the adjacent layer by employing a material having a highly flexible molecular structure as the charge-transporting polymer to be used for forming the adjacent layer or, in the case of a material having the aforementioned molecular structure of low flexibility, by reducing the size of the molecule itself (namely reducing the molecular weight).

Also, the present inventors have studied the factors that cause deterioration of the device performance with time. As a result, it has been found that when the charge-transporting polymer employed has a vinyl skeleton or a polycarbonate skeleton as mentioned above, there is a tendency for the driving voltage to be elevated with the lapse of time, thereby increasing the electric power consumption and further resulting in a deterioration in the light-emitting characteristics.

After studying the factor that causes such a phenomenon, it has been found that a low-molecular component contained in the buffer layer (for example, a star burst amine or CuPc, or a counter ion of the ionic substance used in combination with PEDOT) bleeds with time to the adjacent layer due to the Joule heat generated by the electric field applied to the device, whereby the adjacent layer becomes incapable of exhibiting its own function. Also, such a bleeding phenomenon indicates that the low-molecular component in the buffer layer tends to penetrate into the adjacent layer formed of the charge-transporting polymer having a vinyl or polycarbonate skeleton, that is, there are large or easily formed gaps in the charge-transporting polymer in the adjacent layer.

Therefore, it is thought to be important, in order to suppress the bleeding phenomenon, to form a dense adjacent layer having a high heat resistance capable of avoiding the bleeding of the low-molecular component into the adjacent layer. Accordingly, for preventing the bleeding phenomenon, it may be important that the intermolecular gaps, which facilitate the bleeding of the low-molecular component, can be filled in at the formation of the adjacent layer, and that the thermal relative movement of molecules that lead to the intermolecular gaps does not occur after the formation of the adjacent layer.

Thus, from the standpoint of suppressing the bleeding, it may be required to employ, as a charge-transporting polymer constituting the adjacent layer, a material having high heat resistance (high glass transition point) and a highly flexible and dense molecular structure. However, this condition is contradictory to the use of a charge-transporting polymer having a low molecular weight and having a molecular structure of low flexibility, which is one of the options for suppressing the defects at the film formation.

Alternatively, for fundamental bleeding suppression, it is thought that a material free from the low-molecular component causing the bleeding is used as a charge-injecting material to be employed in the buffer layer or as a component to be used in combination therewith.

In addition, the charge-transporting polymer may be required to have at least a certain number of hopping sites in the molecule for charge transfer, in order to secure a charge mobility affecting the light emission property that is the most important in the organic electroluminescence device. That is, at least a certain molecular size (molecular weight) may be inevitably required. However, as in the case of bleeding suppression, this condition is also contradictory to the use of a charge-transporting polymer having a low molecular weight and having a molecular structure of low flexibility, which is one of the options for suppressing the defects at the film formation.

Thus, there is encountered a dilemma fundamentally difficult to solve, that a charge-transporting polymer lacking flexibility of the molecular structure is difficult to form a dense adjacent layer for suppressing the bleeding phenomenon, while reducing the molecular weight for suppressing the bleeding reduces the heat resistance to thereby induce bleeding or decrease one of the basic characteristics of the device, the charge mobility.

Therefore, in producing an organic electroluminescence device having a buffer layer, for the purpose of securing the basic property of light-emitting characteristics and also in consideration of the workability and the durability that makes long time use practical, it is thought that, in the case where a material causing bleeding is used in the buffer layer, it may be important to employ a charge-transporting polymer for forming the adjacent layer that not only has a sufficient charge mobility but also has a highly flexible and dense molecular structure and high heat resistance. Also, for fundamentally suppressing the bleeding phenomenon, it is thought that it may be required to form the buffer layer with components that basically do not require a low-molecular component causing the bleeding.

With respect to deteriorations in device performances with time, from the view point of improving the charge-injecting efficiency to lower the driving voltage, kinds and compositions of electrode (cathode) materials of metals, metal alloys or metal compounds have been extensively studied. As a result, it has been found that the use of, in place of a single kind of metal conventionally used, alloys composed of alkaline metals and alkaline earth metals such as lithium, magnesium and calcium, which have a low work function, improves the charge (electron) injecting efficiency.

However, in fact, it has been found that diffusion of lithium, calcium or the like to the organic compound layer side with time causes deterioration of the device, whereby the life of the device is not actually improved. Then, it has been found that, for maintaining the electron-injecting property and preventing the diffusion, a thin film of a metal compound such as alkaline metal oxides, alkaline earth metal oxides, alkaline metal halides and alkaline earth metal halides provided as an insulating layer between the organic compound layer and the cathode lower the driving voltage and improve the life of the device.

The present inventors have found that, when the above-mentioned charge-transporting polyester is used in the organic compound layer, effectiveness in prolonging the life of the device by providing an insulating thin layer containing an alkaline metal oxide, alkaline earth metal oxide, alkaline metal halide or alkaline earth metal halide, for preventing diffusion of the metal used in the cathode into the organic compound layer, is even higher than when other charge-transporting materials are used.

In addition in order to further lower the driving voltage of the device for practical use, the present inventors have studied the kinds and compositions of cathode materials that have good compatibility with the charge-transporting polyester having a highly flexible molecular structure and high heat resistance and that further improve the properties of the device using the charge-transporting polyester. Further, the present inventors have studied the thickness of the layer that contains the charge-transporting polyester and is nearest to the anode, and the composition of the buffer layer. As a result, the second aspect of the present invention has been found.

That is, in the second aspect of the invention, the charge-transporting polyester that has sufficient charge mobility, capability of suppressing bleeding of the buffer layer, superior film formability, a flexible and dense molecular structure, and high heat resistance is used to provide a sufficient brightness and improve the stability and durability. Further, in addition to the use of such an organic compound layer, by configuring the cathode so as to include a metal layer (second layer) of a specific metal element and a specific alkaline compound layer (first layer) for preventing the diffusion from the metal layer to the organic compound layer, the driving voltage can be lowered, so that the electric power consumption is suppressed as compared to a conventional device. This effect is significantly higher than in the case of using an organic compound layer containing other charge-transporting materials. That is, effectiveness in prolonging the life is significantly higher than in the case of using an organic compound layer containing other charge-transporting materials.

In addition, when the thickness of the charge-transporting polyester-containing layer that is nearest to the anode is in the specific range, the charge-injecting property, the charge-transporting property and the charge balance are improved, thereby providing a high stability, high brightness and high efficiency, so that the life of the device and the light emitting brightness are further improved.

In addition, since the charge-transporting polyester is used and the buffer layer contains the specific compound that causes little bleeding, a life of the device at higher level is realized.

Further, in the manufacturing process of the device, when all the materials of the organic compound layer are polymer compounds, the organic compound layer can be formed by wet coating processes alone, which provides advantages in simplification of manufacturing, workability, formation over a large area and costs. However, the charge-transporting polyester in the second aspect of the invention can realize stable device characteristics, regardless of the kind of the light-emitting materials used in the light-emitting layer.

### <Charge-Transporting Polyester According to the Invention>

Hereinafter, a charge-transporting polyester including a repeating unit containing, as a partial structure, at least one structure represented by the formula (I-1) or (I-2) will be described.

The charge-transporting polyester has a high mobility in the ester bonding sites and thus shows high flexibility in the molecular structure, and does not easily lose the flexibility of the molecular structure when the molecular weight is increased in order to secure the heat resistance. Therefore, the polyester is superior in film formability, and a wet film forming process can easily be used therefor.

Also, as will be explained later, the charge-transporting polyester can be given a hole transporting ability or an electron transporting ability by a suitable selection of the molecular structure. Therefore, it can be used in the hole transport layer, the light-emitting layer or the charge transport layer according to the purpose.

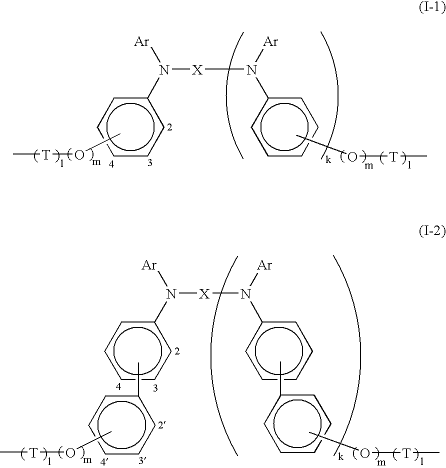

In the formulas (I-1) and (I-2), Ar represents a substituted or unsubstituted monovalent aromatic group.

More specifically, Ar represents a substituted or unsubstituted phenyl group, a substituted or unsubstituted monovalent polycyclic aromatic hydrocarbon with 2 to 10 aromatic rings, a substituted or unsubstituted monovalent condensed ring aromatic hydrocarbon with 2 to 10 aromatic rings, a substituted or unsubstituted monovalent aromatic heterocycle, or a substituted or unsubstituted monovalent aromatic group including at least one aromatic heterocycle.

In the formulas (I-1) and (I-2), a number of the aromatic rings included in the polycyclic aromatic hydrocarbon or the condensed ring aromatic hydrocarbon, which is selected as a structure represented by Ar, is not particularly restricted, but may be 2 to 5, and the condensed ring aromatic hydrocarbon may be a totally condensed ring aromatic hydrocarbon. In the invention, the polycyclic aromatic hydrocarbon and the condensed ring aromatic hydrocarbon means a polycyclic aromatic compound as defined below.

That is, the “polycyclic aromatic hydrocarbon” means a hydrocarbon compound containing two or more aromatic rings which are composed of carbon and hydrogen and which are mutually bonded by a carbon-carbon single bond. Specific examples include biphenyl and terphenyl.

Also, the “condensed ring aromatic hydrocarbon” means a hydrocarbon compound containing two or more aromatic rings which are composed of carbon and hydrogen and which share a pair of mutually adjacent and mutually bonded carbon atoms. Specific examples include naphthalene, anthracene, phenanthrene and fluorene.

Also, the “aromatic heterocycle” means an aromatic ring containing an element other than carbon and hydrogen. A number (Nr) of atoms constituting the cyclic structure may be Nr=5 and/or 6.

Kind and number of the ring-constituting element other than C (hetero atom) are not particularly restricted, but S, N, O and the like may be employed, and the ring structure may contain hetero atoms of two or more kinds and/or two or more in number. In particular, as a heterocycle having a 5-membered structure, thiophene, thiophine, furan, a heterocycle obtained by substituting the carbon atoms in 3- and 4-position thereof with nitrogen atoms, pyrrole, or a heterocycle obtained by substituting carbon atoms in 3- and 4-position thereof with nitrogen atoms may be used, and as a heterocycle having a 6-membered structure, pyridine may be used.

Also, the “aromatic group including an aromatic heterocycle” means a bonding group containing at least one aforementioned aromatic heterocycle in the atomic group constituting the skeleton. Such a group may be entirely composed of a conjugate system or may be partially composed of a non-conjugate system, but it may be entirely composed of a conjugate system in consideration of the charge-transporting ability and the light-emitting efficiency.

The phenyl group, the polycyclic aromatic hydrocarbon, the condensed ring aromatic hydrocarbon, the aromatic heterocycle and the aromatic group including an aromatic heterocycle may have a substituent such as a hydrogen atom, an alkyl group, an alkoxy group, a phenoxy group, an aryl group, an aralkyl group, a substituted amino group, or a halogen atom.

The alkyl group may have 1 to 10 carbon atoms, such as a methyl group, an ethyl group, a propyl group or an isopropyl group. The alkoxy group may have 1 to 10 carbon atoms, such as a methoxy group, an ethoxy group, a propoxy group or an isopropoxy group. The aryl group may have 6 to 20 carbon atoms, such as a phenyl group, or a toluyl group. The araylkyl group may have 7 to 20 carbon atoms, such as a benzyl group or a phenetyl group. A substituent of the substituted amino group can be an alkyl group, an aryl group or an aralkyl group, of which specific examples are the same as described above.

In the formulas (I-1) and (I-2), X represents a substituted or unsubstituted divalent aromatic group. More specifically, X represents a substituted or unsubstituted phenylene group, a substituted or unsubstituted divalent polycyclic aromatic hydrocarbon with 2 to 10 aromatic rings, a substituted or unsubstituted divalent condensed ring aromatic hydrocarbon with 2 to 10 aromatic rings, a substituted or unsubstituted divalent aromatic heterocycle, or a substituted or unsubstituted divalent aromatic group including at least one aromatic heterocycle.

The “polycyclic aromatic hydrocarbon”, the “condensed ring aromatic hydrocarbon”, the “aromatic heterocycle”, and the “aromatic group including an aromatic heterocycle” are the same as those explained above.

In the formulas (I-1) and (I-2), k, m and l each represents 0 or 1; and T represents a linear divalent hydrocarbon with 1 to 6 carbon atoms or a branched divalent hydrocarbon with 2 to 10 carbon atoms, and specifically, a linear divalent hydrocarbon group with 2 to 6 carbon atoms or a branched hydrocarbon with 3 to 7 carbon atoms. Specific examples of the structure of T are shown in the following:

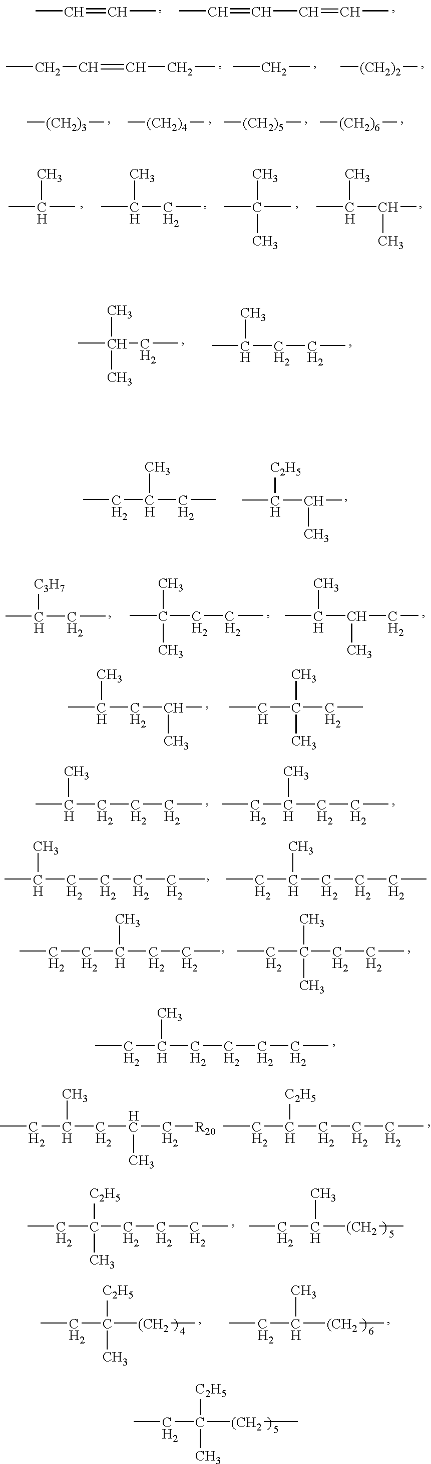

The charge-transporting polyester having a repeating unit containing, as a partial structure, at least one structure represented by the formula (I-1) or (I-2) may be represented by the following formula (II-1) or (II-2). The charge-transporting polyester represented by the formula (II-1) or (II-2) may be a polyester having a hole-transporting ability (hole-transporting polyester).

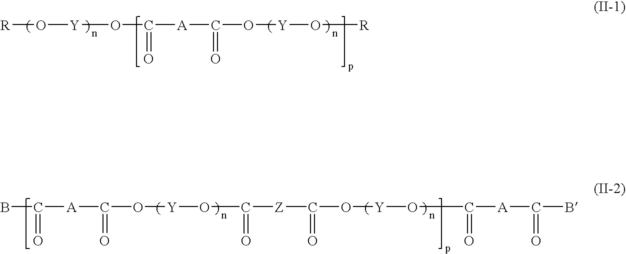

In the formulas (II-1) and (II-2), A represents at least one structure represented by the formula (I-1) or (I-2); R represents a hydrogen atom, an alkyl group, a substituted or unsubstituted aryl group or a substituted or unsubstituted aralkyl group; Y represents a divalent alcohol residue; Z represents a divalent carboxylic acid residue; B and B′ each independently represent —O—(Y—O)ₙ—R or —O—(Y—O)ₙ—CO-Z-CO—O—R′ (in which R, Y and Z have the same meanings as above; R′ represents an alkyl group, a substituted or unsubstituted aryl group or a substituted or unsubstituted aralkyl group; and n represents an integer of 1-5); n represents an integer of 1-5; and p represents an integer of 5-5,000.

In the formulas (II-1) and (II-2), A represents at least one structure represented by the formula (I-1) or (I-2), and two or more structure As may be present in one polymer.

In the formulas (II-1) and (II-2), R represents a hydrogen atom, an alkyl group, a substituted or unsubstituted aryl group, or a substituted or unsubstituted aralkyl group.

The alkyl group may have 1 to 10 carbon atoms, such as a methyl group, an ethyl group, a propyl group or an isopropyl group. The aryl group may have 6 to 20 carbon atoms, such as a phenyl group, or a toluyl group. The araylkyl group may have 7 to 20 carbon atoms, such as a benzyl group or a phenetyl group. A substituent of the substituted aryl group or the substituted aralkyl group can be a hydrogen atom, an alkyl group, an alkoxy group, a substituted amino group or a halogen atom.

In the formulas (II-1) and (II-2), Y represents a divalent alcohol residue and Z represents a divalent carboxylic acid residue. Specific examples of Y and Z include those selected from the following formulas (1) to (7).

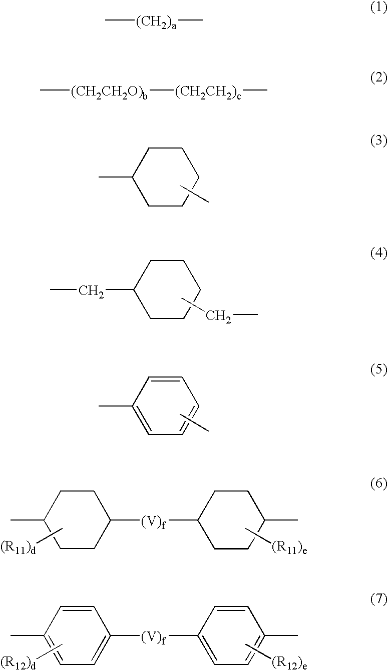

In the formulas (1)-(7), R₁₁ and R₁₂ each independently represent a hydrogen atom, an alkyl group with 1 to 4 carbon atoms, an alkoxy group with 1 to 4 carbon atoms, a substituted or unsubstituted phenyl group, a substituted or unsubstituted aralkyl group, or a halogen atom; a, b, c each represent an integer of 1-10; d and e each represent an integer of 0, 1 or 2; f represents an integer of 0 or 1; and V represents a group selected from the following formulas (8) to (18).

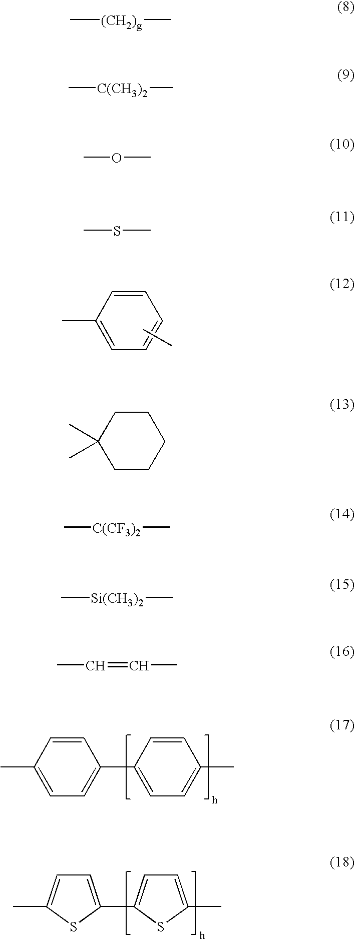

In formulas (8) to (18), g each represents an integer of 1-10; and h each represents an integer of 0-10.

In the formulas (II-1) and (II-2), n represents an integer of 1 to 5; and p representing a degree of polymerization may be within a range of 5 to 5,000, or 10 to 1,000.

The charge-transporting polyester may have a weight-average molecular weight M_{w} within a range of 5,000 to 1,000,000, or 10,000 to 300,000.

Examples of the charge-transporting polyesters of the formulas (I-1) and (I-2) include those disclosed in Japanese Patent Nos. 2,894,257, 2,865,020, 2,865,029, 3,267,115 and 3,058,069.

The charge-transporting polyesters can be synthesized by polymerizing a charge-transporting monomer represented by the following formula (III-1) or (III-2) by a known method as described for example in Jikken Kagaku Koza, 4th edition, Vol. 28 (Maruzen, 1992).

In the formula (III-1) and (III-2), A′ represents a hydroxyl group, a halogen atom, an alkoxyl group [—OR₁₃ (wherein R₁₃ represents an alkyl group (such as a methyl group or an ethyl group))], and Ar, X, T, k, l and m have the same meanings as in the formulas (I-1) and (I-2).

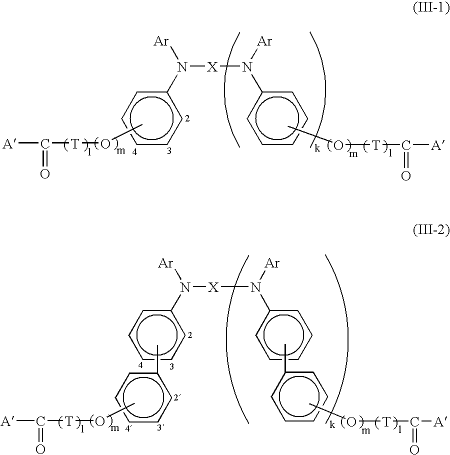

The charge-transporting polyester represented by the formula (II-1) can be synthesized in the following manner.

In the case where A′ is a hydroxyl group, a charge-transporting monomer represented by a formula (III-1) or (III-2) is mixed with a dihydric alcohol represented by HO—(Y—O)ₙ—H (here and hereafter, Y and n are the same as those in the formulas (II-1) and (II-2)) in an approximately equimolar amount and polymerized with an acid catalyst. The acid catalyst can be that employed in an ordinary esterification reaction such as sulfuric acid, toluenesulfonic acid or trifluoroacetic acid, and is employed within a range of 1/10,000 to 1/10 parts by weight (or 1/1,000 to 1/50 parts by weight) with respect to 1 part by weight of the charge-transporting monomer. A solvent capable of forming an azeotrope with water may be employed for eliminating water formed during the polymerization, and there can be employed toluene, chlorobenzene, or 1-chloronaphthalene, which is employed within a range of 1 to 100 parts by weight, or 2 to 50 parts by weight, with respect to 1 part by weight of the charge-transporting monomer. A reaction temperature can be selected arbitrarily, but the reaction may be executed at the boiling point of the solvent in order to eliminate the water generated during the polymerization.

After the reaction, in the case where a solvent is not employed, the product is dissolved in a solvent capable dissolving. In the case where a solvent is employed, the reaction solution is dropwise added to a poor solvent in which a polymer is not easily dissolved, for example an alcohol such as methanol or ethanol, or acetone, thereby precipitating and separating the charge-transporting polyester, which is then sufficiently washed with water or an organic solvent and dried. If necessary, there may be repeated a reprecipitation process of dissolving the polyester in a suitable organic solvent and dripping it into a poor solvent thereby precipitating the charge-transporting polyester. Such a reprecipitation process may be executed under an efficient agitation for example with a mechanical stirrer. The solvent for dissolving the charge-transporting polyester at the reprecipitation process may be employed within a range of 1 to 100 parts by weight or 2 to 50 parts by weight with respect to 1 part by weight of the charge-transporting polyester. Also the poor solvent may be employed within a range of 1 to 1,000 parts by weight or 10 to 500 parts by weight with respect to 1 part by weight of the charge-transporting polyester.

In the case where A′ is a halogen, a charge-transporting monomer represented by a formula (III-1) or (III-2) is mixed with a dihydric alcohol represented by HO—(Y—O)ₙ—H in an approximately equimolar amount and polymerized with an organic basic catalyst such as pyridine or triethylamine. The organic basic catalyst is employed within a range of 1 to 10 equivalents or 2 to 5 equivalents with respect to 1 equivalent of the charge-transporting monomer. A solvent is for example methylene chloride, tetrahydrofuran (THF), toluene, chlorobenzene or 1-chloronaphthalene, and is employed within a range of 1 to 100 parts by weight or 2 to 50 parts by weight, with respect to 1 part by weight of the charge-transporting monomer. A reaction temperature can be selected arbitrarily. After the polymerization, purification is executed by a reprecipitation process as explained above.

In the case of a dihydric alcohol of a high acidity such as a bisphenol, an interfacial polymerization can also be employed. More specifically, a dihydric alcohol is added to water and dissolved by adding an equimolar amount of a base, and polymerization can be executed by adding a solution of a charge-transporting monomer of an equimolar amount to the dihydric alcohol, under vigorous agitation. Water is employed within a range of 1 to 1,000 parts by weight or 2 to 500 parts by weight with respect to 1 part by weight of the dihydric alcohol. A solvent for dissolving the charge-transporting monomer is for example methylene chloride, dichloroethane, trichloroethane, toluene, chlorobenzene or 1-chloronaphthalene. A reaction temperature can be selected arbitrarily. In order to accelerate the reaction, it is effective to employ a phase-transfer catalyst such as an ammonium salt or a sulfonium salt. The phase-transfer catalyst is employed within a range of 0.1 to 10 parts by weight or 0.2 to 5 parts by weight with respect to 1 part by weight of the charge-transporting monomer.

In the case where A′ is an alkoxyl group, the synthesis can be executed by adding, to a charge-transporting monomer represented by a formula (III-1) or (III-2), a dihydric alcohol represented by HO—(Y—O)ₙ—H in an excess amount and executing an ester exchange under heating in the presence of a catalyst for example an inorganic acid such as sulfuric acid or phosphoric acid, titanium alkoxide, a calcium or cobalt salt of acetic acid or carbonic acid, a zinc or lead oxide. The dihydric alcohol is employed within a range of 2 to 100 equivalents or 3 to 50 equivalents with respect to 1 equivalent of the charge-transporting monomer.

The catalyst is employed within a range of 1/10,000 to 1 part by weight or 1/1,000 to 1/2 parts by weight with respect to 1 part by weight of the charge-transporting monomer represented by a formula (III-1) or (III-2). The reaction is executed at a temperature of 200 to 300° C., and after the completion of ester exchange from an alkoxyl group to —O—(Y—O)ₙ—H, a reaction may be executed under a reduced pressure in order to accelerate a polymerization by elimination of HO—(Y—O)ₙ—H. It is also possible to employ a high-boiling point solvent capable of forming an azeotrope with HO—(Y—O) n-H such as 1-chloronaphthalene, thereby executing the reaction at the atmospheric pressure while eliminating HO—(Y—O)ₙ—H by azeotropy.

Also, the charge-transporting polyester represented by the formula (II-2) can be synthesized utilizing a charge-transporting monomer represented by a formula (IV-1) or (IV-2).

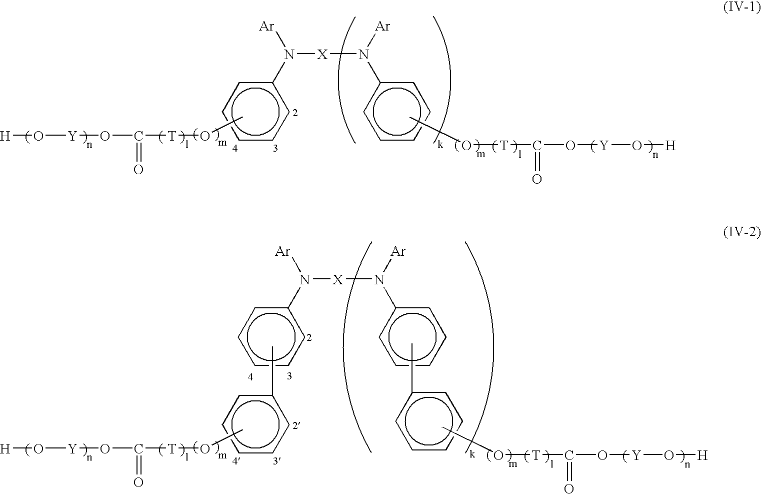

In the formula (IV-1) and (IV-2), Ar, X, Y, T, k, l, m and n have the same meanings as those described above.

The charge-transporting polyester represented by the formula (II-2) can be synthesized in the following manner.

At first, a charge-transporting monomer represented by a formula (III-1) or (III-2) (wherein A′ may be a hydroxyl group, a halogen, or an alkoxyl group) is reacted with an excess amount of a dihydric alcohol represented by HO—(Y—O)ₙ—H to generate a charge-transporting monomer represented by a formula (IV-1) or (IV-2).

Then, the charge-transporting polyester represented by the formula (II-2) can be synthesized in the same manner as in the synthesis of the charge-transporting polyester of the formula (II-1) by reacting with a divalent carboxylic acid or a divalent carboxylic acid halide, employing a charge-transporting monomer represented by a formula (IV-1) or (IV-2) instead of the charge-transporting monomer represented by a formula (III-1) or (III-2).

### <Layer Structure of the Organic Electroluminescence Device According to the First Aspect of the Invention>

In the following, the layer structure of the organic electroluminescence device according to the first aspect of the invention will be described in detail.

The organic electroluminescence device according to the first aspect of the invention has a layer structure including an anode and a cathode, at least one of which is transparent or semi-transparent, and an organic compound layer that includes one or more layers including a light-emitting layer and is sandwiched between the electrodes. The organic compound layer includes at least a light-emitting layer, and at least one layer included in the organic compound layer contains at least one charge-transporting polyester.

In addition, the thickness of the layer that is nearest, of the at least one layer containing at least one charge-transporting polyester, to the anode is in the range of 20 to 100 nm (or 20 to 80 nm or 20 to 50 nm). This layer is a light-emitting layer that has a charge-transporting ability, when the organic compound layer have a single layer structure. This layer may be a hole transport layer, when the organic compound layer have a function-separated structure (multi-layered structure).

In the organic electroluminescence device according to the first aspect of the invention, in the case where the organic compound layer is formed by a light-emitting layer alone, this light-emitting layer means a light-emitting layer having a charge-transporting ability, and the light-emitting layer having a charge-transporting ability contains the charge-transporting polyester.

Also, in the case where the organic compound layer further includes one or more other layers in addition to the light-emitting layer (in the case of a function-separated structure of two or more layers), the one or more layers other than the light-emitting layer are carrier transport layers such as a hole transport layer, an electron-transport layer, or a hole transport layer and an electron-transport layer, and the charge-transporting polyester is contained in at least one of these layers.

More specifically, the organic compound layer may have, for example, a structure including at least a hole transport layer, a light-emitting layer and an electron transport layer, or a structure including at least a hole transport layer and a light-emitting layer. These layer structures may be formed by sequentially laminating the respective layers from the anode side. In this case, the charge-transporting polyester may be contained in at least one of these layers (a hole transport layer, an electron transport layer, a light-emitting layer). The charge-transporting polyester may be contained as a hole-transporting material. For example, the charge-transporting polyester may be contained in at least the hole transport layer.

Further, in the organic electroluminescence device according to the first aspect of the invention, the light-emitting layer may contain a charge-transporting material (a hole-transporting material or an electron-transporting material other than the aforementioned charge-transporting polyester), and the details of such a charge-transporting material will be explained later.

In the following, the organic electroluminescence device according to the first aspect of the invention will be explained in detail with reference to the accompanying drawings, but is not limited thereto.

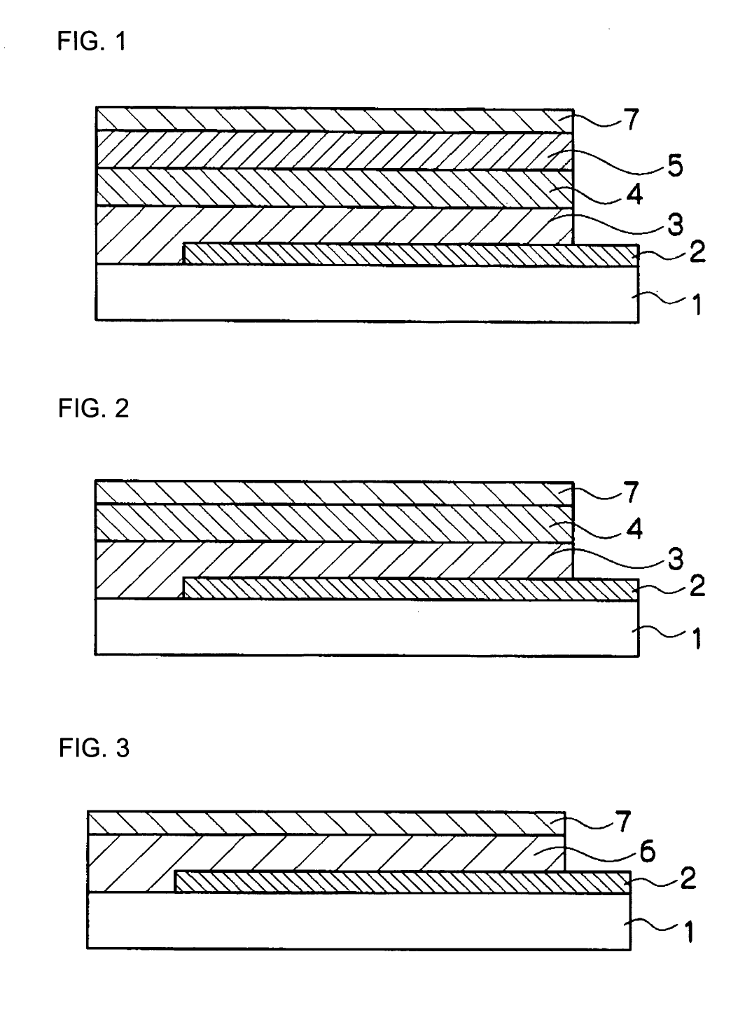

FIGS. 1 to 3 are schematic cross-sectional views for explaining the layer structure of the organic electroluminescence device according to the first aspect of the invention, in which FIGS. 1 and 2 show examples where the organic compound layer has a 2- or 3-layered structure, while FIG. 3 shows an example where the organic compound layer has a single-layered structure. In FIGS. 1 to 3, members having the same function are represented by the same number.

An organic electroluminescence device shown in FIG. 1 is formed by sequentially laminating, on a transparent insulating substrate 1, a transparent electrode 2, a hole transport layer 3, a light-emitting layer 4, an electron transport layer 5 and a back electrode 7. An organic electroluminescence device shown in FIG. 2 is formed by sequentially laminating, on a transparent insulating substrate 1, a transparent electrode 2, a hole transport layer 3, a light-emitting layer 4 and a back electrode 7. An organic electroluminescence device shown in FIG. 3 is formed by sequentially laminating, on a transparent insulating substrate 1, a transparent electrode 2, a light-emitting layer 6 having a charge-transporting ability and a back electrode 7.

In FIGS. 1 to 3, the transparent electrode 2 is an anode, and the back electrode 7 is a cathode. In the following, each component will be explained in detail.

The hole transport layer 3 and/or the electron transport layer 5 may be a layer containing the charge-transporting polyester, in the case of the layer structure of the organic electroluminescence device shown in FIG. 1. The hole transport layer 3 may be a layer containing the charge-transporting polyester, in the case of the layer structure of the organic electroluminescence device shown in FIG. 2. The light-emitting layer 6 having a charge-transporting ability may be a layer containing the charge-transporting polyester, in the case of the layer structure of the organic electroluminescence device shown in FIG. 3. For example, the charge-transporting polyester may be used as a hole-transporting material.

The transparent insulating substrate 1 may be transparent in order to transmit the emitted light, and can be composed for example of glass or plastics but is not limited thereto. The transparent electrode 2 may be transparent in order to transmit the emitted light as the transparent insulating substrate and may have a large work function (ionization potential) in order to inject holes, and may be composed, for example, of an oxide film such as indium tin oxide (ITO), tin oxide (NESA), indium oxide and zinc oxide, or deposited or sputtered gold, platinum or palladium, but is not limited thereto.

The electron transport layer 5 may be formed by only the aforementioned charge-transporting polyester that is provided with a desired function (electron transporting ability), or may be formed by mixing and dispersing an electron transporting material other than the charge-transporting polyester within a range of 1 to 50 wt. % for regulating the electron mobility for the purpose of further improving the electrical characteristics.

Such an electron transporting material may be an oxadiazole derivative, a nitro-substituted fluorenone derivative, a diphenoquinone derivative, a thiopyrandioxide derivative or a fluorenylidene methane derivative. Specific examples includes the following compounds (V-1) to (V-3), but are not limited thereto. In the case where the electron transport layer 5 is formed without the charge-transporting polyester, the layer 5 is formed by such an electron transporting material.

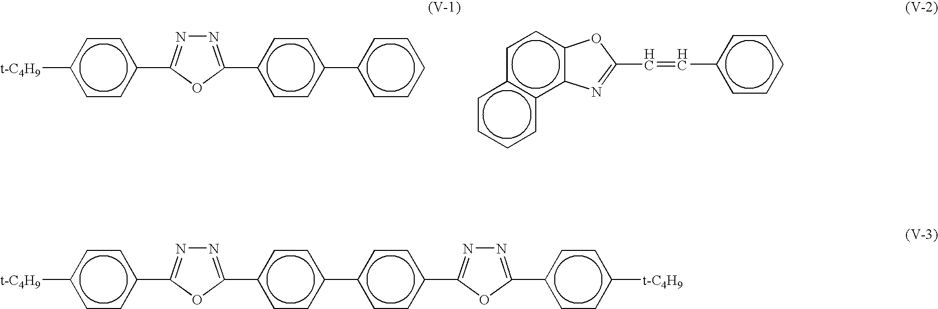

The hole transport layer 3 may be formed by only the aforementioned charge-transporting polyester that is provided with a desired function (hole-transporting ability), or may be formed by mixing and dispersing a hole-transporting material other than the charge-transporting polyester within a range of 1 to 50 wt. % for regulating the hole mobility.

Such a hole-transporting material may be a tetraphenylenediamine derivative, a triphenylamine derivative, a carbazole derivative, a stilbene derivative, an arylhydrazone derivative, or a porphyrin compound, and specific examples include the following compounds (VI-1) to (VI-7), but a tetraphenylenediamine derivative may be used because of the good compatibility with the charge-transporting polyester. Also, the hole-transporting material may be used in combination with another general-purpose resin. In the case where the hole transport layer 3 is formed without the charge-transporting polyester, it is formed with such a hole-transporting material. In the compound (VI-7), n (integer) may be within a range of 10 to 100,000 or 1,000 to 50,000.

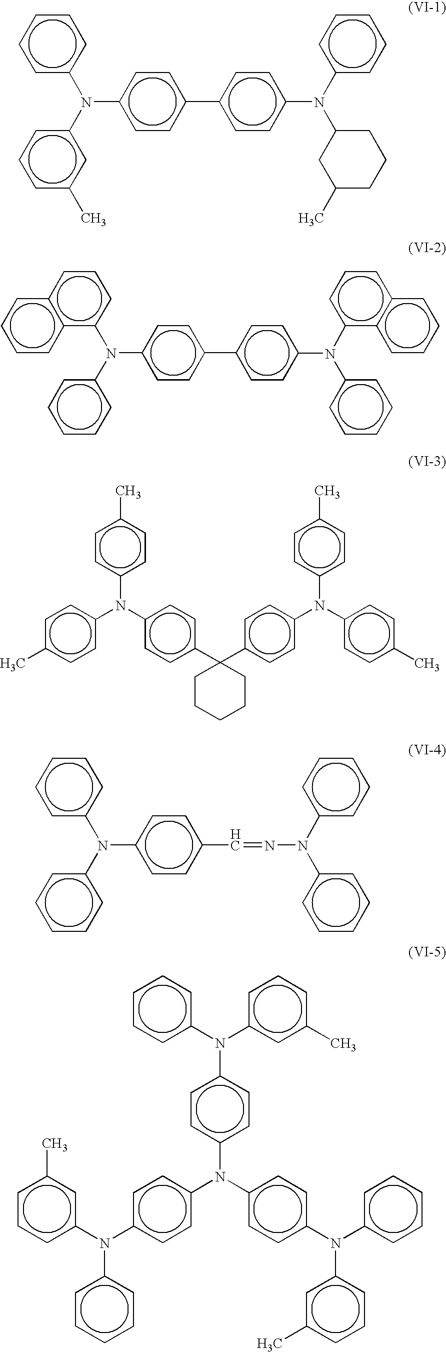

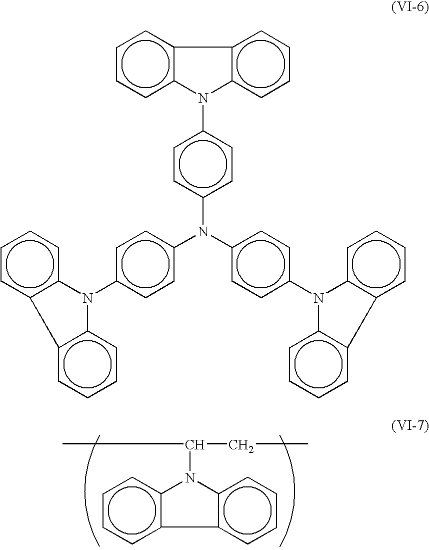

In the light-emitting layer 4, as a light-emitting material, a compound showing a high fluorescence quantum yield in a solid state may be used. In the case where the light-emitting material is an organic low-molecular compound, it is required that a satisfactory thin film can be formed by vacuum deposition or by coating and drying a solution or a dispersion containing the organic low-molecular compound and a binder resin. In the case of a high-molecular compound, it is required that a satisfactory thin film can be formed by coating and drying a solution or a dispersion containing such a high-molecular compound itself.

Examples of the organic low-molecular compound include a chelate organometallic complex, a polycyclic or condensed-ring aromatic compound, a perylene derivative, a coumarine derivative, a styrylarylene derivative, a silol derivative, an oxazole derivative, an oxathiazole derivative and an oxadiazole derivative, and examples of the high-molecular compound include a polyparaphenylene derivative, a polyparaphenylenevinylene derivative, a polythiophene derivative, a polyacetylene derivative and a polyfluorene derivative. Specific examples include the following compounds (VII-1) to (VII-17), but are not limited thereto. In the structures (VII-13) to (VII-17), Ar and X represent a monovalent or divalent group of a structure similar to Ar and X in the formulas (I-1) and (I-2); n and x each represent an integer of 1 or larger; and y represents 0 or 1.

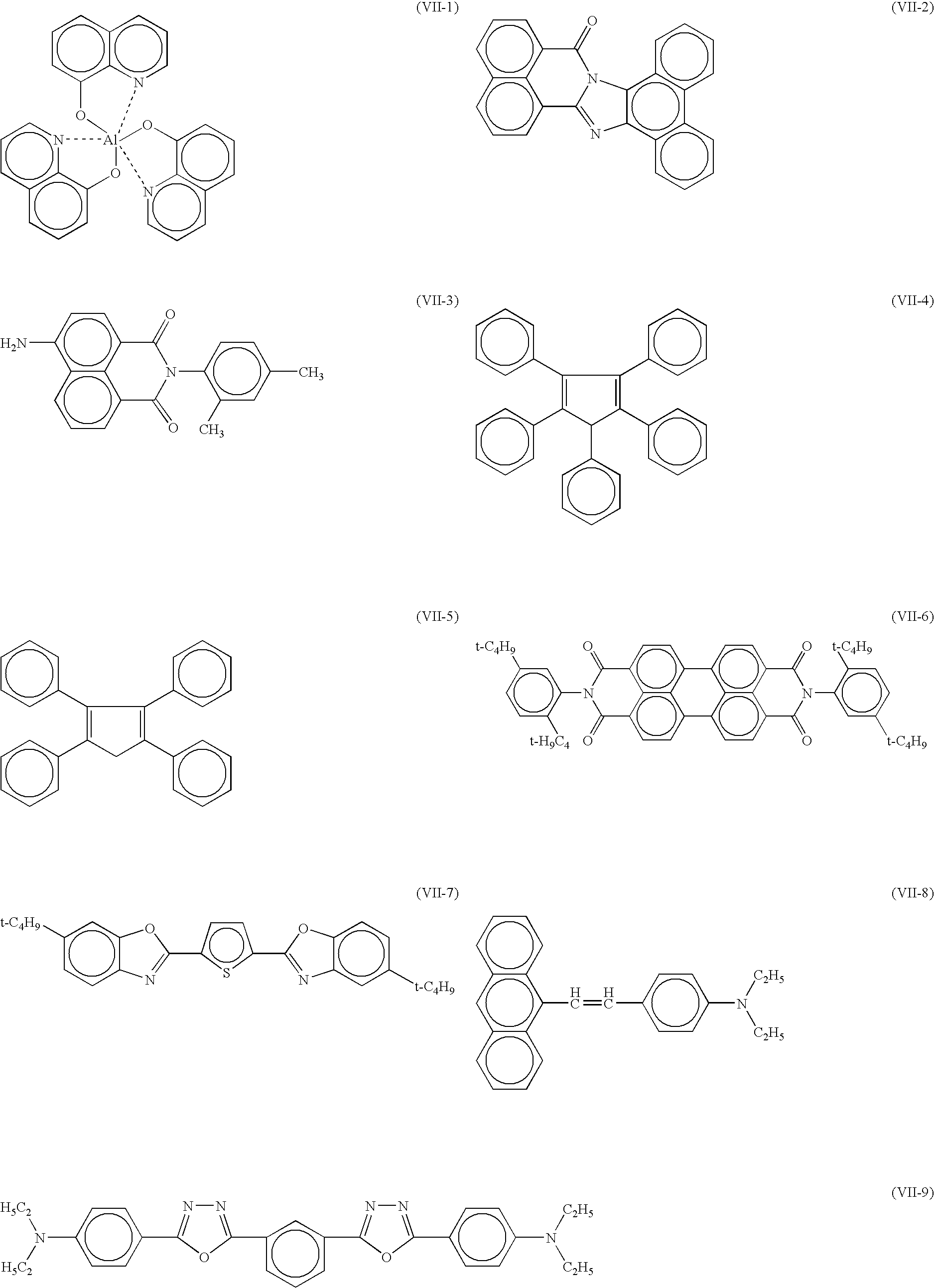

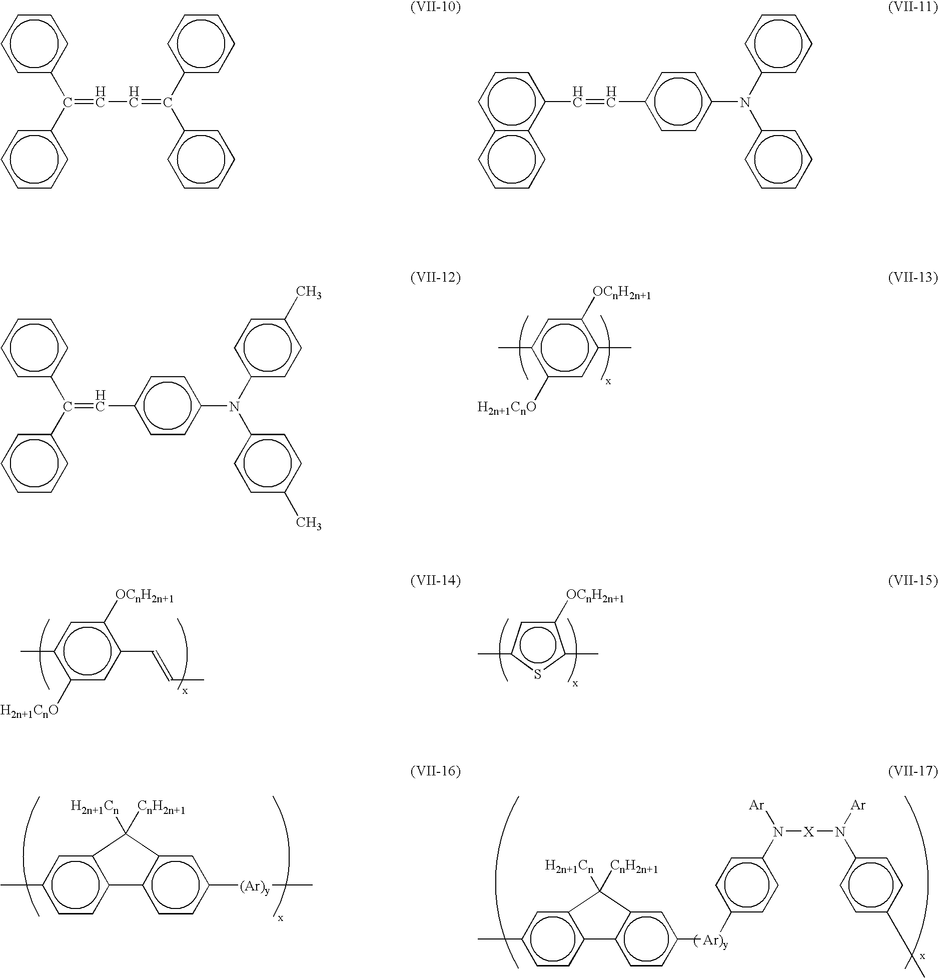

Also, for the purpose of improving the durability or the light-emitting efficiency of the organic electroluminescence device, the aforementioned light-emitting material may be doped with, as a guest material, a dye compound different from the light-emitting material. In the case where the light-emitting layer is formed by vacuum deposition, the doping is achieved by co-deposition, and, in the case where the light-emitting layer is formed by coating and drying a solution or a dispersion, the doping is achieved by mixing in such a solution or dispersion. A doping proportion of the dye compound in the light-emitting layer may be about 0.001 to 40 wt. %, or 0.01 to 10 wt. %.

A dye compound employed in such doping may be an organic compound showing a good compatibility with the light-emitting material and not hindering a satisfactory thin film formation of the light-emitting layer, and may be a DCM derivative, a quinacridone derivative, a rubrene derivative or a porphyrin compound. Specific examples include the following compounds (VIII-1) to (VIII-4), but are not limited thereto.

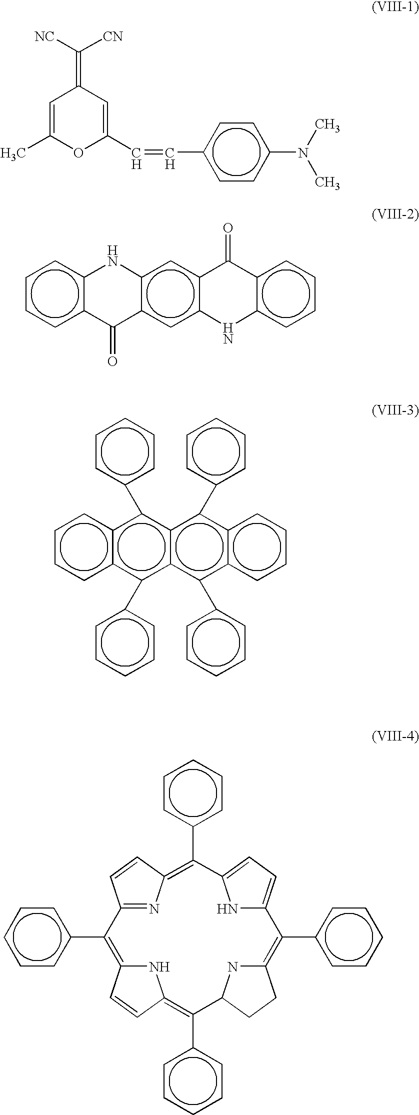

The light-emitting layer 4 may be formed by the light-emitting material alone, or may be formed, for the purpose of further improving the electrical characteristics and the light-emitting characteristics, by mixing and dispersing the charge-transporting polyester in the light-emitting material within a range of 1 to 50 wt. %, or by mixing and dispersing a charge-transporting material other than the charge-transporting polyester in the light-emitting polymer within a range of 1 to 50 wt. %.

Also, in the case where the charge-transporting polymer also has a light-emitting property, it may be employed as a light-emitting material, and, in such a case, the light-emitting layer may also be formed, for the purpose of further improving the electrical characteristics and the light-emitting characteristics, by mixing and dispersing a charge-transporting material other than the charge-transporting polyester in the light-emitting material within a range of 1 to 50 wt. %.

The light-emitting layer 6 having a charge-transporting ability may be formed by a material prepared by dispersing, in the aforementioned charge-transporting polyester provided with a desired function (electron transporting ability or hole transporting ability), the aforementioned light-emitting material (VII-1) to (VII-17) as a light-emitting material in an amount of 50 wt. % or less. In this case, in order to regulate the balance of the holes and the electrons injected in the organic electroluminescence device, a charge-transporting material other than the charge-transporting polyester may be dispersed within a range of 10 to 50 wt. %.

Examples of such a charge-transporting material include, in the case of regulating the electron mobility, as an electron transporting material, an oxadiazole derivative, a nitro-substituted fluorenone derivative, a diphenoquinone derivative, a thiopyrandioxide derivative and a fluorenylidene methane derivative. Specific examples include the compounds (V-1) to (V-3). Also, an organic compound not showing a strong electronic interaction with the charge-transporting polyester may be used. Examples thereof include the following compound (IX), but are not limited thereto.

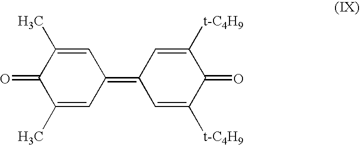

Also, in the case of regulating the hole mobility, as a hole-transporting material, a tetraphenylenediamine derivative, a triphenylamine derivative, a carbazole derivative, a stilbene derivative, an arylhydrazone derivative and a porphyrin compound are exemplified, and specific examples include the compounds (VI-1) to (VI-7), but a tetraphenylenediamine derivative may be used because of the good compatibility with the charge-transporting polyester.

The back electrode 7 is formed by a metal that can be vacuum deposited and has a low work function for electron injection. Specifically, the back electrode 7 is, although not shown, for example, formed of a first layer that is in contact with the organic compound layer (light-emitting layer 3, electron transport layer 5, or light-emitting layer 6 having a charge-transporting ability) and a second layer that is in contact with the first layer. Further, the back electrode 7 may be formed by laminating the first layer and the second layer, and further an aluminum layer (a third layer) that is in contact with the second layer, in this order from the organic compound layer side. Owing to this structure, the electron injecting property is improved, while the stability of the electrode is maintained.

The thickness of the first layer may be 1 to 50 nm (or 1 to 20 nm). The thickness of the second layer may be 10 to 100 nm (or 10 to 20 nm). The thickness of the third layer may be 10 to 200 nm (or 50 to 150 nm).

The first layer contains at least one selected from the group consisting of alkaline metal oxides, alkaline earth metal oxides, alkaline metal halides and alkaline earth metal halides.

Examples of the alkaline metal oxides include Li₂O, Na₂O and K₂O. Examples of the alkaline earth metal oxides include MgO, CaO and BaO. Examples of the alkaline metal halides include fluorides such as LiF, NaF and KF. Examples of the alkaline earth metal halides include fluorides such as MgF₂, CaF₂ and BaF₂.

Of these examples, from the view points of electron injection property and stability as electrode, alkaline metal halides and alkaline earth metal halides, specifically LiF and Li₂O, may be used.

The second layer contains at least one selected from the group consisting of alkaline metals and alkaline earth metals.

Examples of the alkaline metals include lithium, sodium, potassium, rubidium and cesium. Examples of the alkaline earth metals include magnesium, calcium, strontium and barium.

Of these examples, from the view points of electron injection property and stability as electrode, alkaline earth metals, specifically calcium (Ca), may be used.

Each of the first to third layers may be a single layer containing one of the above-mentioned metals or metal compounds, or a layer containing two or more of the above-mentioned metals or metal compounds.

On the back electrode 7 (on the surface opposite to the surface that is in contact with the organic compound layer), a protective layer may be provided for avoiding deterioration of the device by moisture or oxygen. Specific examples of materials for the protective layer include metals such as In, Sn, Pb, Au, Cu, Ag and Al, metal oxides such as MgO, SiO₂ and TiO₂, and resins such as polyethylene, polyurea and polyimide. The protective layer can be formed for example by vacuum deposition, sputtering, plasma polymerization, CVD or coating.

The organic electroluminescence devices shown in FIGS. 1 to 3 can be prepared in the following procedure.

At first, on a transparent electrode 2, a hole transport layer 3, a light-emitting layer 4, an electron transport layer 5, and a light-emitting layer 6 having a charge-transporting ability are formed according to the layer structure of the organic electroluminescence device. The hole transport layer 3, the light-emitting layer 4, the electron transport layer 5, and the light-emitting layer 6 having a charge-transporting ability are formed by vacuum deposition of each material, or by film formation by spin coating or dip coating on the transparent electrode 2 with a coating liquid obtained by dissolving or dispersing each material in an organic solvent.

According to the layer structure of the organic electroluminescence device, a light-emitting layer 4 and an electron transport layer 5 are formed by vacuum deposition of each material, or by film formation by spin coating or dip coating on the hole transport layer 3 or light-emitting layer 4 with a coating liquid obtained by dissolving or dispersing each material in an organic solvent.

When a polymer material is used as a charge-transporting material or a light-emitting material, each layer may be formed by a coating method with a coating liquid, or by an inkjet method.

The hole transport layer 3, the light-emitting layer 4 and the electron transport layer 5 thus formed may have a thickness of 20 to 100 nm, or 30 to 80 nm. The light-emitting layer 6 having a charge-transporting ability may have a thickness of 20 to 200 nm, or 30 to 200 nm.

The dispersion state of the materials (the charge-transporting polyester, light-emitting material and so forth) may be a molecular dispersion state or a fine particle dispersion state. In the film formation with a coating liquid, in order to achieve a molecular dispersion state, the dispersion solvent has to be a common solvent for these materials, while, in order to obtain a fine particle dispersion state, the dispersion solvent has to be selected in consideration of the solubility and dispersibility of the materials. For obtaining a fine particle dispersion state, there can be utilized a ball mill, a sand mill, a paint shaker, an attriter, a homogenizer or an ultrasonic method.

Finally, a back electrode 7 is formed by vacuum deposition on the light-emitting layer 4, the electron transport layer 5, or the light-emitting layer 6 having a charge-transporting ability to obtain the organic electroluminescence devices shown in FIGS. 1 to 3.

These organic electroluminescence devices according to the first aspect of the invention can emit light by application of a DC voltage of 4 to 20 V with a current density of 1-200 mA/cm² between the pair of electrodes.

### <Layer Structure of the Organic Electroluminescence Device According to the Second Aspect of the Invention>

In the following, the layer structure of the organic electroluminescence device according to the second aspect of the invention will be described in detail.

The organic electroluminescence device according to the second aspect of the invention has a layer structure including an anode and a cathode, at least one of which is transparent or semi-transparent, and an organic compound layer that includes two or more layers including a light-emitting layer and a buffer layer and is sandwiched between the electrodes. The buffer layer contains one or more charge-injecting materials, and is provided in contact with the anode. At least one layer included in the organic compound layer contains at least one charge-transporting polyester.

In addition, the thickness of the layer that is nearest, of the at least one layer containing at least one charge-transporting polyester, to the anode is in the range of 20 to 100 nm (or 20 to 80 nm or 20 to 50 nm). This layer is a light-emitting layer that have a charge-transporting ability, when the organic compound layer have a single layer structure. This layer may be a hole transport layer, when the organic compound layer have a function-separated structure (multi-layered structure).

In the organic electroluminescence device according to the second aspect of the invention, in the case where the organic compound layer is formed by only a buffer layer and a light-emitting layer, this light-emitting layer means a light-emitting layer having a charge-transporting ability, and the light-emitting layer having a charge-transporting ability contains the charge-transporting polyester.

Also, in the case where the organic compound layer further includes one or more other layers in addition to the buffer layer and the light-emitting layer (in the case of a function-separated structure of three or more layers), the one or more layers other than the buffer layer and the light-emitting layer are carrier transport layers such as a hole transport layer, an electron-transport layer, or a hole transport layer and an electron-transport layer, and the charge-transporting polyester is contained in at least one of these layers.

More specifically, the organic compound layer may have, for example, a structure including at least a buffer layer, a hole transport layer, a light-emitting layer and an electron transport layer, or a structure including at least a buffer layer, a hole transport layer and a light-emitting layer. In this case, the charge-transporting polyester may be contained in at least one of these layers (a hole transport layer, an electron transport layer, a light-emitting layer). The charge-transporting polyester may be contained as a hole-transporting material. For example, the charge-transporting polyester may be contained in at least the hole transport layer.

When the organic compound layer is formed by only a buffer layer and a light-emitting layer, the buffer layer is formed between the anode and the light-emitting layer. When the organic compound layer has a structure including at least a buffer layer, a hole transport layer, a light-emitting layer and an electron transport layer, the buffer layer is formed between the anode and the hole transport layer. When the organic compound layer has a structure including at least a buffer layer, a hole transport layer and a light-emitting layer, the buffer layer is formed between the anode and the hole transport layer.

Further, in the organic electroluminescence device according to the second aspect of the invention, the light-emitting layer may contain a charge-transporting material (a hole-transporting material or an electron-transporting material other than the aforementioned charge-transporting polyester), and the details of such a charge-transporting material will be explained later.

In the following, the organic electroluminescence device according to the second aspect of the invention will be explained in detail with reference to the accompanying drawings, but is not limited thereto.

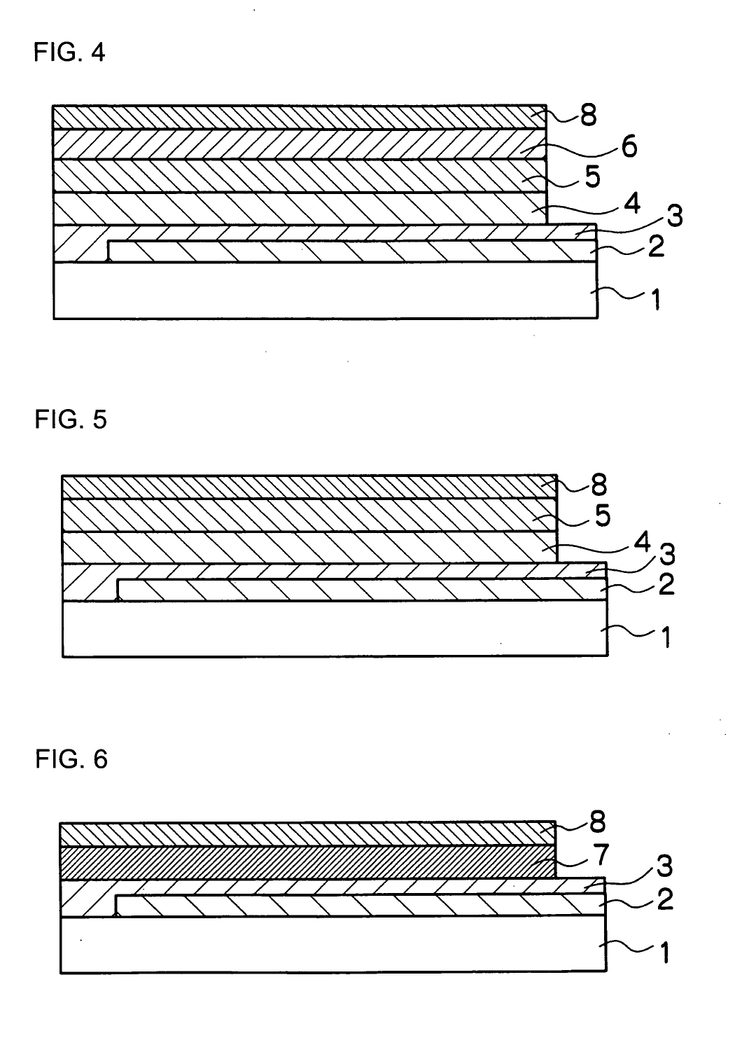

FIGS. 4 to 6 are schematic cross-sectional views for explaining the layer structure of the organic electroluminescence device according to the second aspect of the invention, in which FIGS. 4 and 5 show examples where the organic compound layer has a 3- or 4-layered structure, while FIG. 6 shows an example where the organic compound layer has a 2-layered structure. In FIGS. 4 to 6, members having the same function are represented by the same number.

An organic electroluminescence device shown in FIG. 4 is formed by sequentially laminating, on a transparent insulating substrate 1, a transparent electrode 2, a buffer layer 3, a hole transport layer 4, a light-emitting layer 5, an electron transport layer 6 and a back electrode 8. An organic electroluminescence device shown in FIG. 5 is formed by sequentially laminating, on a transparent insulating substrate 1, a transparent electrode 2, a buffer layer 3, a hole transport layer 4, a light-emitting layer 5 and a back electrode 8. An organic electroluminescence device shown in FIG. 6 is formed by sequentially laminating, on a transparent insulating substrate 1, a transparent electrode 2, a buffer layer 3, a light-emitting layer 7 having a charge-transporting ability and a back electrode 8.

In FIGS. 4 to 6, the transparent electrode 2 is an anode, and the back electrode 8 is a cathode. In the following, each component will be explained in detail.

The hole transport layer 4 and/or the electron transport layer 6 may be a layer containing the charge-transporting polyester, in the case of the layer structure of the organic electroluminescence device shown in FIG. 4. The hole transport layer 4 may be a layer containing the charge-transporting polyester, in the case of the layer structure of the organic electroluminescence device shown in FIG. 5. The light-emitting layer 7 having a charge-transporting ability may be a layer containing the charge-transporting polyester, in the case of the layer structure of the organic electroluminescence device shown in FIG. 6. For example, the charge-transporting polyester may be used as a hole-transporting material.

The transparent insulating substrate 1 may be transparent in order to transmit the emitted light, and can be composed for example of glass or plastics but is not limited thereto. The transparent electrode 2 may be transparent in order to transmit the emitted light as the transparent insulating substrate and may have a large work function (ionization potential) in order to inject holes, and may be composed, for example, of an oxide film such as indium tin oxide (ITO), tin oxide (NESA), indium oxide and zinc oxide, or deposited or sputtered gold, platinum or palladium, but is not limited thereto.

The buffer layer 3 is formed in contact with the anode (transparent electrode 2) and contains one or more charge-injecting materials. At least one of the charge-injecting materials is a charge-transporting polymer having a structural unit represented by the following formula (II). In the formula (II), n is an integer of 100 to 10000.

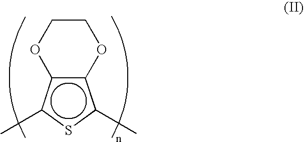

The charge-transporting polymer represented by the formula (II) is a material that is called PEDOT (polyethylene-dioxythiophene), which often cannot singly secure a sufficient conductivity and therefore may be used in combination with an ionic substance containing a counter ion (such as Na ion) such as PSS (polystyrenesulfonic acid) for improving the charge-injecting property of the buffer layer 3.

As a mixture containing the charge-transporting polymer represented by the formula (II) and polystyrenesulfonic acid, there can be employed a known material such as Baytron P (manufactured by Bayer AG; a mixed aqueous dispersion containing polyethylene dioxide thiophene and polystyrenesulfonic acid).

The charge injecting material may have an ionization potential of 5.2 eV or less, or 5.1 eV or less, in order to improve charge injection into a layer provided in contact with a surface of the buffer layer 3 opposite to the surface thereof in contact with the anode (namely, the hole transport layer 4 in FIGS. 4 and 5, and the light-emitting layer 7 having a charge transport ability in FIG. 6). The number of the buffer layer 3 is not limited, but may be 1 or 2.

The buffer layer 3 may further contain other materials not having a charge injecting property such as a binder resin, if necessary, in addition to the above-mentioned materials.

The electron transport layer 6 may be formed by only the aforementioned charge-transporting polyester that is provided with a desired function (electron transporting ability), or may be formed by mixing and dispersing an electron transporting material other than the charge-transporting polyester within a range of 1 to 50 wt. % for regulating the electron mobility for the purpose of further improving the electrical characteristics.

Such an electron transporting material may be an oxadiazole derivative, a nitro-substituted fluorenone derivative, a diphenoquinone derivative, a thiopyrandioxide derivative or a fluorenylidene methane derivative. Specific examples includes the following compounds (VI-1) to (VI-3), but are not limited thereto. In the case where the electron transport layer 6 is formed without the charge-transporting polyester, the layer 6 is formed by such an electron transporting material.

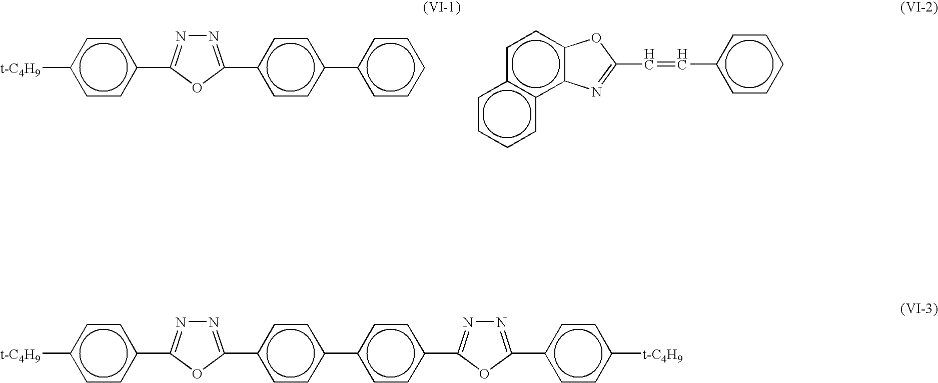

The hole transport layer 4 may be formed by only the aforementioned charge-transporting polyester that is provided with a desired function (hole-transporting ability), or may be formed by mixing and dispersing a hole-transporting material other than the charge-transporting polyester within a range of 1 to 50 wt. % for regulating the hole mobility.

Such a hole-transporting material may be a tetraphenylenediamine derivative, a triphenylamine derivative, a carbazole derivative, a stilbene derivative, an arylhydrazone derivative, or a porphyrin compound, and specific examples include the following compounds (VII-1) to (VII-7), but a tetraphenylenediamine derivative may be used because of the good compatibility with the charge-transporting polyester. Also, the hole-transporting material may be used in combination with another general-purpose resin. In the case where the hole transport layer 4 is formed without the charge-transporting polyester, it is formed with such a hole-transporting material. In the compound (VII-7), n (integer) may be within a range of 10 to 100,000 or 1,000 to 50,000.

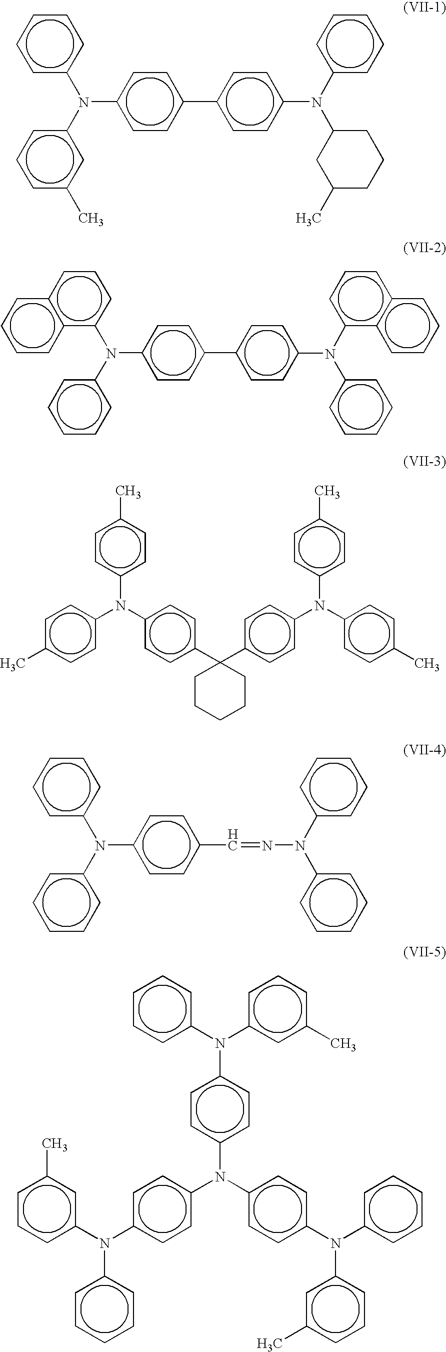

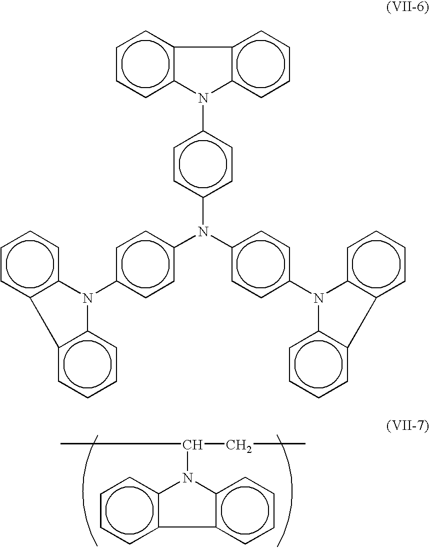

In the light-emitting layer 5, as a light-emitting material, a compound showing a high fluorescence quantum yield in a solid state may be used. In the case where the light-emitting material is an organic low-molecular compound, it is required that a satisfactory thin film can be formed by vacuum deposition or by coating and drying a solution or a dispersion containing the organic low-molecular compound and a binder resin. In the case of a high-molecular compound, it is required that a satisfactory thin film can be formed by coating and drying a solution or a dispersion containing such a high-molecular compound itself.

Examples of the organic low-molecular compound include a chelate organometallic complex, a polycyclic or condensed-ring aromatic compound, a perylene derivative, a coumarine derivative, a styrylarylene derivative, a silol derivative, an oxazole derivative, an oxathiazole derivative and an oxadiazole derivative, and example of the high-molecular compound include a polyparaphenylene derivative, a polyparaphenylenevinylene derivative, a polythiophene derivative, a polyacetylene derivative and a polyfluorene derivative. Specific examples include the following compounds (VIII-1) to (VIII-17), but are not limited thereto.

In the structures (VIII-13) to (VIII-17), Ar and X represent a monovalent or divalent group of a structure similar to Ar and X in the formulas (I-1) and (I-2); n and x each represent an integer of 1 or larger; and y represents 0 or 1.

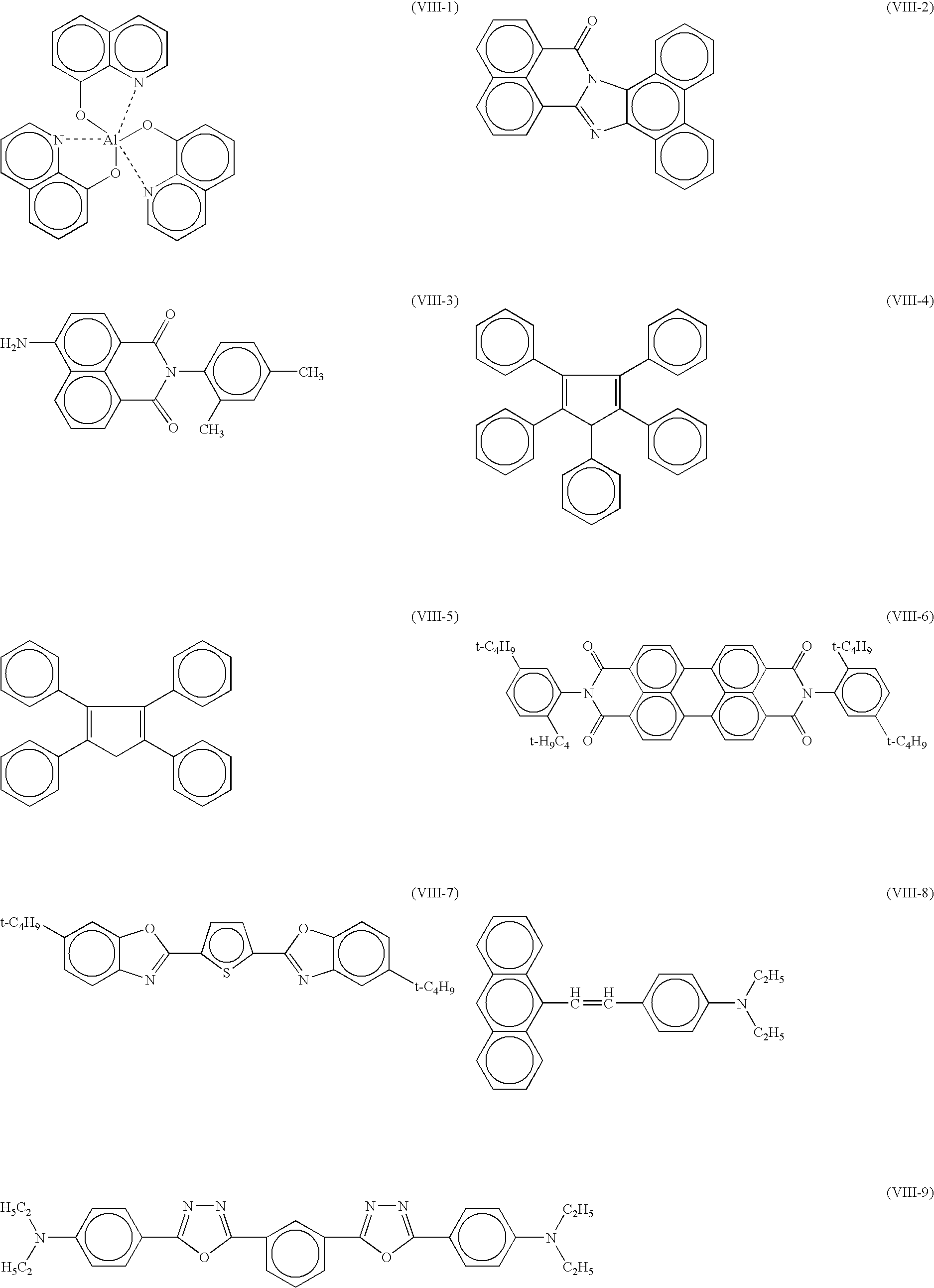

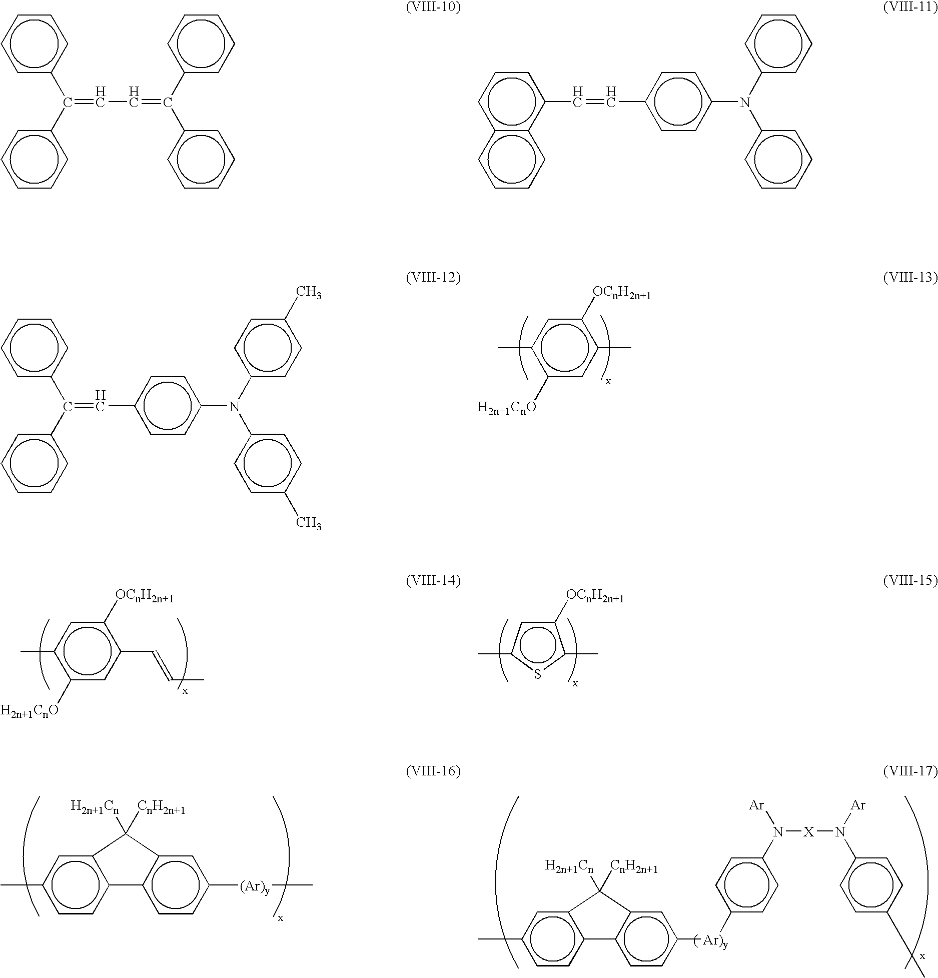

Also, for the purpose of improving the durability or the light-emitting efficiency of the organic electroluminescence device, the aforementioned light-emitting material may be doped with, as a guest material, a dye compound different from the light-emitting material. In the case where the light-emitting layer is formed by vacuum deposition, the doping is achieved by co-deposition, and, in the case where the light-emitting layer is formed by coating and drying a solution or a dispersion, the doping is achieved by mixing in such a solution or dispersion. A doping proportion of the dye compound in the light-emitting layer may be about 0.001 to 40 wt. %, or 0.01 to 10 wt. %.

A dye compound employed in such doping may be an organic compound showing a good compatibility with the light-emitting material and not hindering a satisfactory thin film formation of the light-emitting layer, and may be a DCM derivative, a quinacridone derivative, a rubrene derivative or a porphyrin compound. Specific examples include the following compounds (IX-1) to (IX-4), but are not limited thereto.

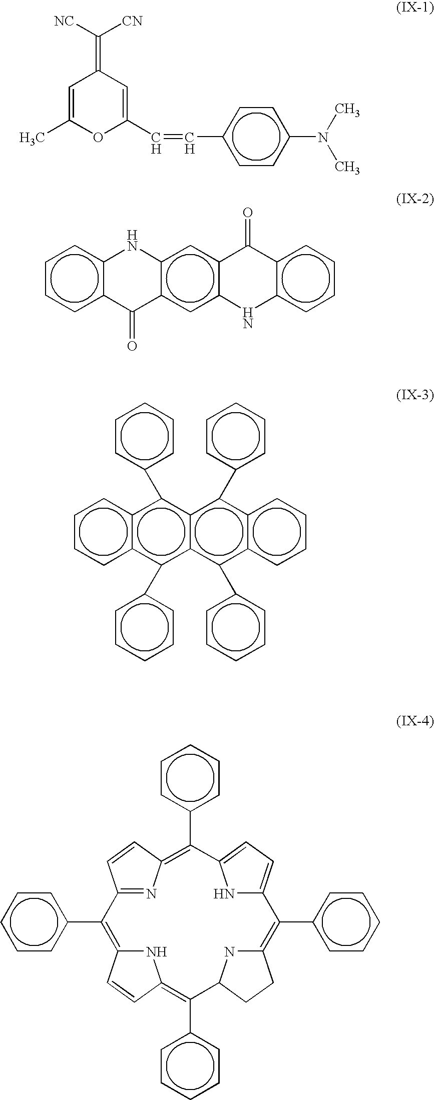

The light-emitting layer 5 may be formed by the light-emitting material alone, or may be formed, for the purpose of further improving the electrical characteristics and the light-emitting characteristics, by mixing and dispersing the charge-transporting polyester in the light-emitting material within a range of 1 to 50 wt. %, or by mixing and dispersing a charge-transporting material other than the charge-transporting polyester in the light-emitting polymer within a range of 1 to 50 wt. %.

Also, in the case where the charge-transporting polymer also has a light-emitting property, it may be employed as a light-emitting material, and, in such a case, the light-emitting layer may also be formed, for the purpose of further improving the electrical characteristics and the light-emitting characteristics, by mixing and dispersing a charge-transporting material other than the charge-transporting polyester in the light-emitting material within a range of 1 to 50 wt. %.

The light-emitting layer 7 having a charge-transporting ability may be formed by a material prepared by dispersing, in the aforementioned charge-transporting polyester provided with a desired function (electron transporting ability or hole transporting ability), the aforementioned light-emitting material (VIII-1) to (VIII-17) as a light-emitting material in an amount of 50 wt. % or less. In this case, in order to regulate the balance of the holes and the electrons injected in the organic electroluminescence device, a charge-transporting material other than the charge-transporting polyester may be dispersed within a range of 10 to 50 wt. %.

Examples of such a charge-transporting material include, in the case of regulating the electron mobility, as an electron transporting material, an oxadiazole derivative, a nitro-substituted fluorenone derivative, a diphenoquinone derivative, a thiopyrandioxide derivative and a fluorenylidene methane derivative. Specific examples include the compounds (VI-1) to (VI-3). Also, an organic compound not showing a strong electronic interaction with the charge-transporting polyester may be used. Examples thereof include the following compound (X), but are not limited thereto.

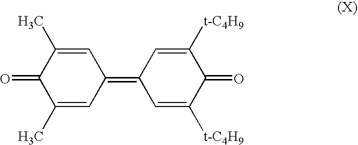

Also, in the case of regulating the hole mobility, as a hole-transporting material, a tetraphenylenediamine derivative, a triphenylamine derivative, a carbazole derivative, a stilbene derivative, an arylhydrazone derivative and a porphyrin compound are exemplified, and specific examples include the compounds (VII-1) to (VII-7), but a tetraphenylenediamine derivative may be used because of the good compatibility with the charge-transporting polyester.

The back electrode 8 is formed by a metal that can be vacuum deposited and has a low work function for electron injection. Specifically, the back electrode 8 is, although not shown, for example, formed of a first layer that is in contact with the organic compound layer (light-emitting layer 5, electron transport layer 6, or light-emitting layer 7 having a charge-transporting ability) and a second layer that is in contact with the first layer. Further, the back electrode 8 may be formed by laminating the first layer and the second layer, and further an aluminum layer (a third layer) that is in contact with the second layer, in this order from the organic compound layer side. Owing to this structure, the electron injecting property is improved, while the stability of the electrode is maintained.

The thickness of the first layer may be 1 to 50 nm (or 1 to 20 nm). The thickness of the second layer may be 10 to 100 nm (or 10 to 20 nm). The thickness of the third layer may be 10 to 200 nm (or 50 to 150 nm).

The first layer contains at least one selected from the group consisting of alkaline metal oxides, alkaline earth metal oxides, alkaline metal halides and alkaline earth metal halides.

Examples of the alkaline metal oxides include Li₂O, Na₂O and K₂O. Examples of the alkaline earth metal oxides include MgO, CaO and BaO. Examples of the alkaline metal halides include fluorides such as LiF, NaF and KF. Examples of the alkaline earth metal halides include fluorides such as MgF₂, CaF₂ and BaF₂.

Of these examples, from the view points of electron injection property and stability as electrode, alkaline metal halides and alkaline earth metal halides, specifically LiF and Li₂O, may be used.

The second layer contains at least one selected from the group consisting of alkaline metals and alkaline earth metals.

Examples of the alkaline metals include lithium, sodium, potassium, rubidium and cesium. Examples of the alkaline earth metals include magnesium, calcium, strontium and barium.

Of these examples, from the view points of electron injection property and stability as electrode, alkaline earth metals, specifically calcium (Ca), may be used.

Each of the first to third layers may be a single layer containing one of the above-mentioned metals or metal compounds, or a layer containing two or more of the above-mentioned metals or metal compounds.

On the back electrode 8 (on the surface opposite to the surface that is in contact with the organic compound layer), a protective layer may be provided for avoiding deterioration of the device by moisture or oxygen. Specific examples of materials for the protective layer include metals such as In, Sn, Pb, Au, Cu, Ag and Al, metal oxides such as MgO, SiO₂ and TiO₂, and resins such as polyethylene, polyurea and polyimide. The protective layer can be formed for example by vacuum deposition, sputtering, plasma polymerization, CVD or coating.

The organic electroluminescence devices shown in FIGS. 4 to 6 can be prepared in the following procedure.

At first, a buffer layer 3 is formed on a transparent electrode 2 formed in advance on a transparent insulating substrate 1 by forming a film on the transparent electrode 2 by spin coating or dip coating with a coating liquid obtained by dissolving or dispersing the material in an organic solvent. Then, on the buffer layer 3, a hole transport layer 4, a light-emitting layer 5, an electron transport layer 6 and a light-emitting layer 7 having a charge transporting ability are formed according to the layer structure of the organic electroluminescence device. Then, layers are sequentially laminated on these layers according to the layer structure of the organic electroluminescence device.

The hole transport layer 4, the light-emitting layer 5, the electron transport layer 6 and the light-emitting layer 7 having a charge transporting ability are formed, as described above, by vacuum deposition of a material constituting each layer, or by forming a film by spin coating or dip coating with a coating liquid obtained by dissolving or dispersing each material in an organic solvent.

When a polymer material is used as a charge-transporting material or a light-emitting material, each layer may be formed by a coating method with a coating liquid, or by an inkjet method.

The thickness of the buffer layer thus formed may be 1 to 200 nm or 10 to 150 nm. Owing to such a thickness of the buffer layer, the device can have a good hole injecting property and a long life.

The hole transport layer 4, the light-emitting layer 3 and the electron transport layer 6 may have a thickness of 20 to 100 nm, or 30 to 80 nm. The light-emitting layer 7 having a charge-transporting ability may have a thickness of 20 to 200 nm, or 30 to 200 nm.

The dispersion state of the materials (the charge-transporting polyester, light-emitting material and so forth) may be a molecular dispersion state or a fine particle dispersion state. In the film formation with a coating liquid, in order to achieve a molecular dispersion state, the dispersion solvent has to be a common solvent for these materials, while, in order to obtain a fine particle dispersion state, the dispersion solvent has to be selected in consideration of the solubility and dispersibility of the materials. For obtaining a fine particle dispersion state, there can be utilized a ball mill, a sand mill, a paint shaker, an attriter, a homogenizer or an ultrasonic method.

Finally, a back electrode 8 is formed by vacuum deposition on the light-emitting layer 5, the electron transport layer 6, or the light-emitting layer 7 having a charge-transporting ability to obtain the organic electroluminescence devices shown in FIGS. 4 to 6.

These organic electroluminescence devices according to the second aspect of the invention can emit light by application of a DC voltage of 4 to 20 V with a current density of 1-200 mA/cm² between the pair of electrodes.

### EXAMPLES

In the following, the present invention will be further explained with examples, but the invention is not limited to the examples.

### <Examples According to the First Aspect of the Invention>

### —Synthesis of Charge-Transporting Polyester—

### Synthesis Example 1A

2.0 g of a following compound (X-1), 8.0 g of ethylene glycol and 0.1 g of tetrabutoxytitanium are charged in a 50-ml flask and are heated under agitation for 5 hours at 190° C. under a nitrogen flow.

After the consumption of the compound (X-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of tetrahydrofuran (THF). Then the insoluble substance is filtered off with a 0.2 μm polytetrafluoroethylene (PTFE) filter, and the filtrate is subjected to a reprecipitation by dripping into 500 ml of methanol under agitation, thereby precipitating a polymer. The obtained polymer is separated by filtration, washed sufficiently with methanol and dried to obtain 1.9 g of hole-transporting polyester (X-2).

The hole-transporting polyester (X-2), in a measurement of molecular weight distribution by gel permeation chromatography (GPC), shows a weight-average molecular weight Mw=7.24×10⁴ (converted as styrene), and a ratio (Mw/Mn) of a number-average molecular weight Mn and a weight-average molecular weight Mw of 1.87.

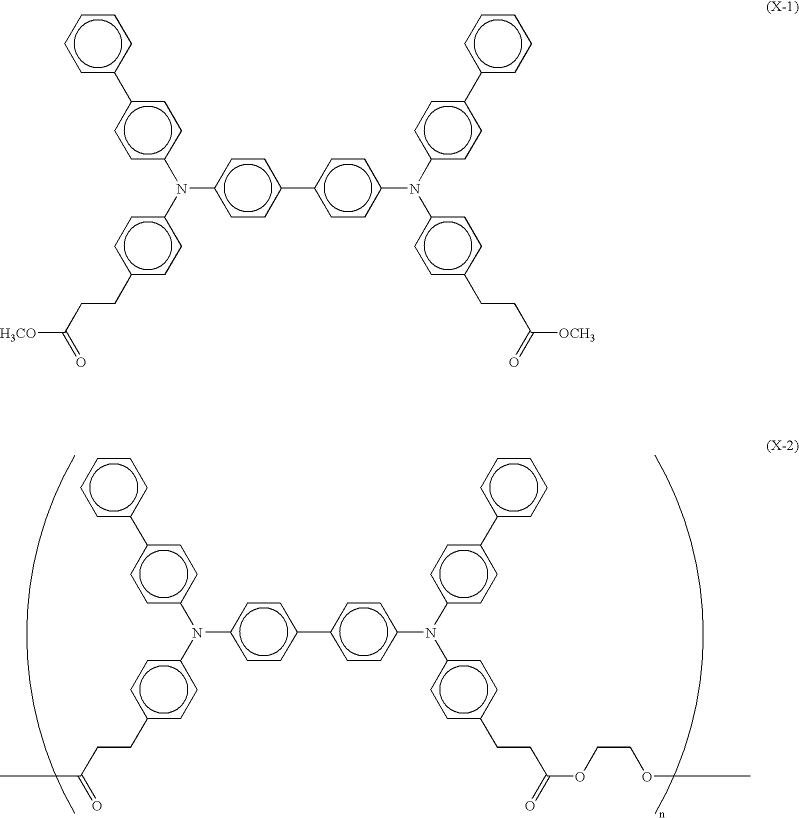

### Synthesis Example 2A

2.0 g of a following compound (XI-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XI-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of THF. Then the insoluble substance is filtered off with a 0.2 μm PTFE filter, and the filtrate is subjected to a reprecipitation by dripping into 500 ml of methanol under agitation, thereby precipitating a polymer. The obtained polymer is separated by filtration, washed sufficiently with methanol and dried to obtain 1.7 g of electron-transporting polyester (XI-2).

The electron-transporting polyester (XI-2), in a measurement of molecular weight distribution by gel permeation chromatography (GPC), shows Mw=1.08×10⁵ (converted as styrene), and Mw/Mn=2.31.

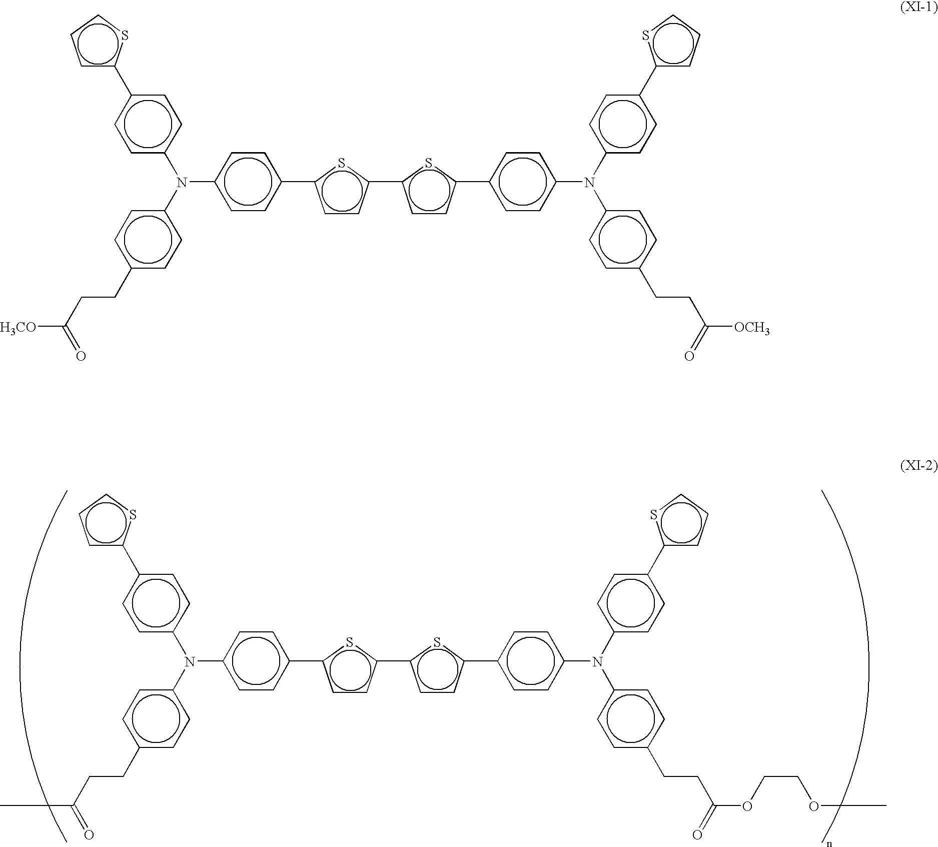

### Synthesis Example 3A

2.0 g of a following compound (XII-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XII-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of THF. Then the insoluble substance is filtered off with a 0.2 μm PTFE filter, and the filtrate is subjected to a reprecipitation by dripping into 500 ml of methanol under agitation, thereby precipitating a polymer. The obtained polymer is separated by filtration, washed sufficiently with methanol and dried to obtain 1.85 g of hole-transporting polyester (XII-2).

The hole-transporting polyester (XII-2), in a measurement of molecular weight distribution by gel permeation chromatography (GPC), shows Mw=7.08×10⁴ (converted as styrene), and Mw/Mn=2.00.

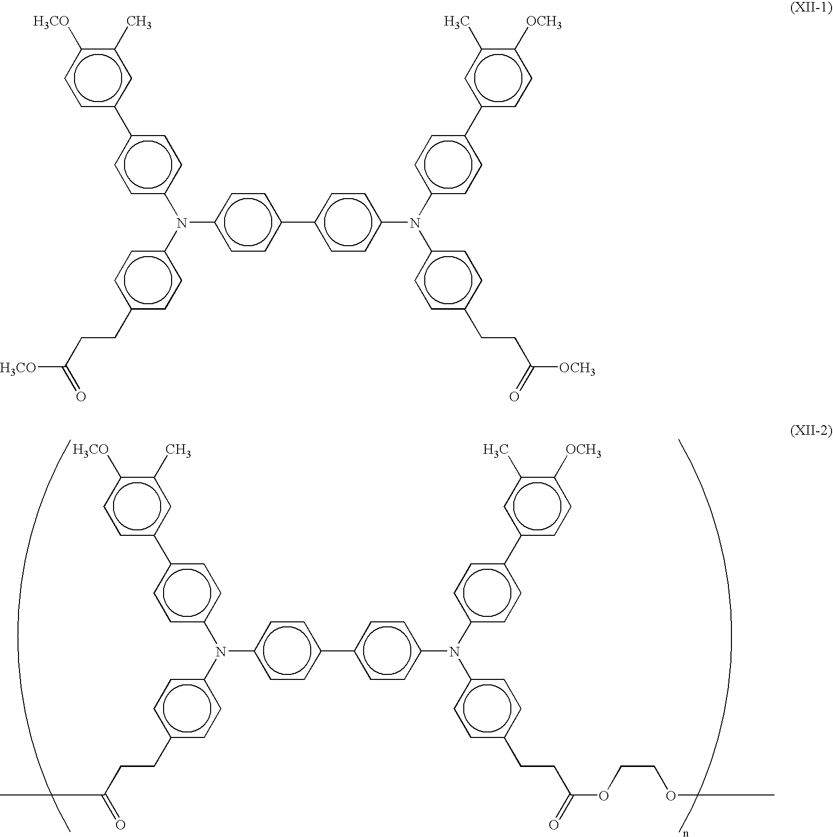

### Synthesis Example 4A

2.0 g of a following compound (XIII-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XIII-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of THF. Then the insoluble substance is filtered off with a 0.2 μm PTFE filter, and the filtrate is subjected to a reprecipitation by dripping into 500 ml of methanol under agitation, thereby precipitating a polymer. The obtained polymer is separated by filtration, washed sufficiently with methanol and dried to obtain 1.9 g of hole-transporting polyester (XIII-2).

The hole-transporting polyester (XIII-2), in a measurement of molecular weight distribution by gel permeation chromatography (GPC), shows Mw=1.12×10⁵ (converted as styrene), and Mw/Mn=1.71.

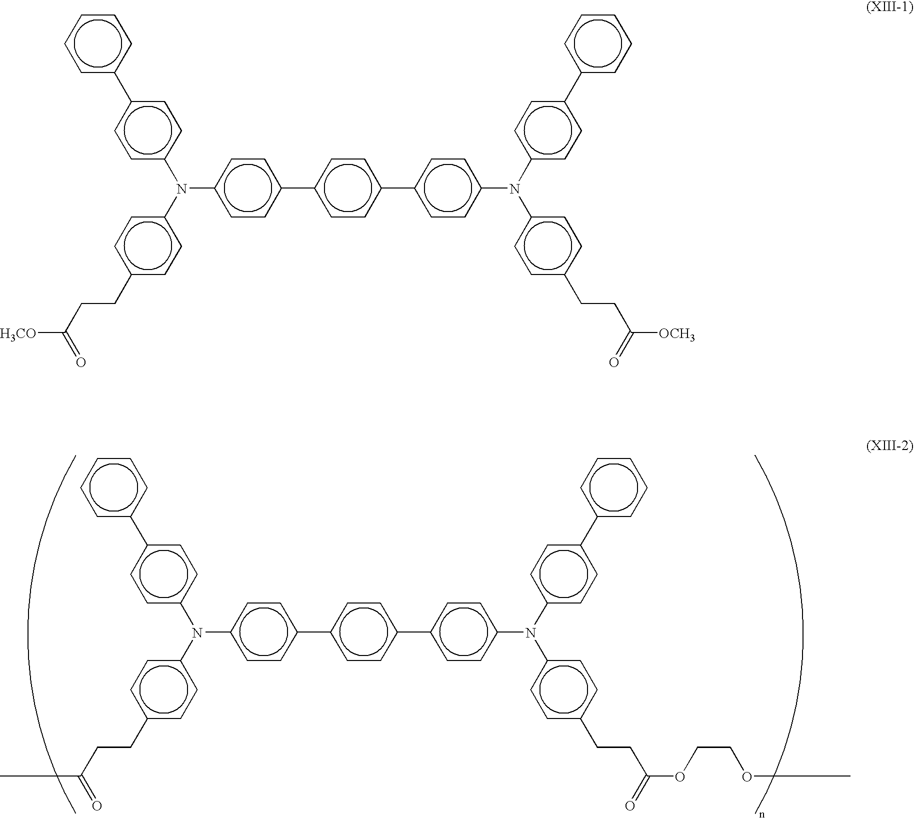

### —Preparation of Organic Electroluminescence Device—

Then an organic electroluminescence device is prepared in the following manner, utilizing thus synthesized charge-transporting polyester.

### Example 1A

A substrate on which a rectangular ITO electrode having a width of 2 mm is formed by etching is prepared as a substrate with a transparent electrode (hereinafter called a “glass substrate with an ITO electrode”).

Then, a chlorobenzene solution containing 1 wt. % of a charge-transporting polyester [compound (X-2)] (Mw=7.24×10⁴) as a hole-transporting material is filtered with a polytetrafluoroethylene (PTFE) filter having a mesh size of 0.1 μm, and spin coated on the washed and dried glass substrate with an ITO electrode at the ITO electrode side of the substrate to form a hole transport layer having a thickness of 30 nm. After the hole transport layer is sufficiently dried, a xylene solution containing 1 wt. % of a light-emitting polymer [following compound (XIV), polyfluorene compound, Mw≈10⁵] as a light-emitting material is filtered with a polytetrafluoroethylene (PTFE) filter having a mesh size of 0.1 μm, and spin coated on the hole transport layer to form a light-emitting layer having a thickness of 60 nm.

After the formed light-emitting layer is sufficiently dried, a chlorobenzene solution containing 2 wt. % of a charge-transporting polyester [compound (XV-2)] (Mw=1.08×10⁵) as an electron-transporting material is filtered with a PTFE filter having a mesh size of 0.1 μm, and is spin coated on the light-emitting layer to form an electron transport layer having a thickness of 30 nm. Finally, as a cathode, a 1 nm thickness of lithium fluoride (LiF) layer (first layer), a 20 nm thickness of calcium (Ca) layer (second layer) and a 150 nm thickness of aluminum layer (third layer) are laminated in this order by deposition to form a back electrode having a width of 2 mm and a thickness of 0.15 μm so as to cross the ITO electrode. The formed organic electroluminescence device has an effective area of 0.04 cm².

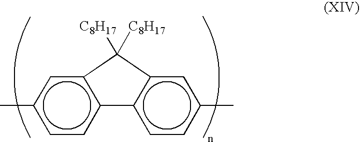

### Example 2A

A chlorobenzene solution containing 1 wt. % of a charge-transporting polyester [compound (X-2)] (Mw=7.24×10⁴) as a hole-transporting material is filtered with a polytetrafluoroethylene (PTFE) filter having a mesh size of 0.1 μm, and spin coated on the washed and dried glass substrate with an ITO electrode at the ITO electrode side of the substrate to form a hole transport layer having a thickness of 30 nm. After the hole transport layer is sufficiently dried, a xylene solution containing 1 wt. % of a light-emitting polymer [compound (XIV), polyfluorene compound, Mw≈10⁵] as a light-emitting material is filtered with a polytetrafluoroethylene (PTFE) filter having a mesh size of 0.1 μm, and spin coated on the hole transport layer to form a light-emitting layer having a thickness of 60 mm.

After the formed light-emitting layer is sufficiently dried, finally, as a cathode, a 1 nm thickness of lithium fluoride (LiF) layer (first layer), a 20 nm thickness of calcium (Ca) layer (second layer) and a 150 nm thickness of aluminum layer (third layer) are laminated in this order by deposition to form a back electrode having a width of 2 mm and a thickness of 0.15 μm so as to cross the ITO electrode. The formed organic electroluminescence device has an effective area of 0.04 cm².

### Example 3A

A chlorobenzene solution containing 5 wt. % of a mixture prepared by mixing 0.5 parts by weight of a charge-transporting polyester [compound (X-2)] (Mw=7.24×10⁴) as a hole-transporting material and 0.1 part by weight of a light-emitting polymer [compound (XIV), polyfluorene compound, Mw≈10⁵] as a light-emitting material is filtered with a polytetrafluoroethylene (PTFE) filter having a mesh size of 0.1 μm, and spin coated on the washed and dried glass substrate with an ITO electrode at the ITO electrode side of the substrate to form a light-emitting layer having a charge-transporting ability and having a thickness of 50 nm.

After the formed light-emitting layer having a charge-transporting ability is sufficiently dried, finally, as a cathode, a 1 nm thickness of lithium fluoride (LiF) layer (first layer), a 20 nm thickness of calcium (Ca) layer (second layer) and a 150 nm thickness of aluminum layer (third layer) are laminated in this order by deposition to form a back electrode having a width of 2 mm and a thickness of 0.15 μm so as to cross the ITO electrode. The formed organic electroluminescence device has an effective area of 0.04 cm².

### Example 4A

An organic electroluminescence device is prepared in the same manner as in Example 1A, except that a light-emitting polymer [following compound (XV), polyparaphenylenevinylene (PPV) compound, Mw≈10⁵] as a light-emitting material is spin coated to form a light-emitting layer having a thickness of 60 nm.

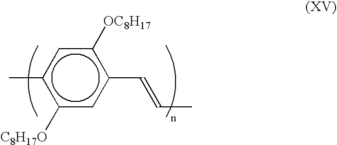

### Example 5A

An organic electroluminescence device is prepared in the same manner as in Example 2A, except that a light-emitting polymer [compound (XV), polyparaphenylenevinylene (PPV) compound, Mw≈10⁵] as a light-emitting material is spin coated to form a light-emitting layer having a thickness of 60 nm.

### Example 6A

An organic electroluminescence device is prepared in the same manner as in Example 3A, except that 0.1 part by weight of a light-emitting polymer [compound (XV), polyparaphenylenevinylene (PPV) compound, Mw≈10⁵] as a light-emitting material is mixed to form a light-emitting layer having a charge-transporting ability and having a thickness of 50 nm.

### Example 7A

An organic electroluminescence device is prepared in the same manner as in Example 2A, except that a charge-transporting polyester [compound (XII-2)] (Mw=7.08×10⁴) as a hole-transporting material is spin coated to form a hole transport layer having a thickness of 30 nm.

### Example 8A

An organic electroluminescence device is prepared in the same manner as in Example 5A, except that a charge-transporting polyester [compound (XII-2)] (Mw=7.08×10⁴) as a hole-transporting material is spin coated to form a hole transport layer having a thickness of 30 nm.

### Example 9A

An organic electroluminescence device is prepared in the same manner as in Example 2A, except that a charge-transporting polyester [compound (XIII-2)] (Mw=1.12×10⁵) as a hole-transporting material is spin coated to form a hole transport layer having a thickness of 30 nm.

### Example 10A

An organic electroluminescence device is prepared in the same manner as in Example 5A, except that a charge-transporting polyester [compound (XIII-2)] (Mw=1.12×10⁵) as a hole-transporting material is spin coated to form a hole transport layer having a thickness of 30 nm.

### Comparative Example 1A

An organic electroluminescence device is prepared in the same manner as in Example 1A, except that a charge-transporting polyester [compound (X-2)] (Mw=7.24×10⁴) as a hole-transporting material is spin coated to form a hole transport layer having a thickness of 15 nm.

### Comparative Example 2A

An organic electroluminescence device is prepared in the same manner as in Example 2A, except that a charge-transporting polyester [compound (X-2)] (Mw=7.24×10⁴) as a hole-transporting material is spin coated to form a hole transport layer having a thickness of 15 nm.

### Comparative Example 3A

An organic electroluminescence device is prepared in the same manner as in Example 3A, except that a chlorobenzene solution containing a mixture prepared by mixing 0.5 parts by weight of a charge-transporting polyester [compound (X-2)] (Mw=7.24×10⁴) as a hole-transporting material and 0.1 part by weight of a light-emitting polymer [compound (XIV), polyfluorene compound, Mw≈10⁵] as a light-emitting material is spin coated to form a light-emitting layer having a charge-transporting ability and having a thickness of 15 nm.

### Comparative Example 4A

An organic electroluminescence device is prepared in the same manner as in Example 1A, except that a charge-transporting polyester [compound (X-2)] (Mw=7.24×10⁴) as a hole-transporting material is spin coated to form a hole transport layer having a thickness of 110 nm.

### Comparative Example 5A

An organic electroluminescence device is prepared in the same manner as in Example 2A, except that a charge-transporting polyester [compound (X-2)] (Mw=7.24×10⁴) as a hole-transporting material is spin coated to form a hole transport layer having a thickness of 110 mm.

### Comparative Example 6A

An organic electroluminescence device is prepared in the same manner as in Example 3A, except that a chlorobenzene solution containing a mixture prepared by mixing 0.5 parts by weight of a charge-transporting polyester [compound (X-2)] (Mw=7.24×10⁴) as a hole-transporting material and 0.1 part by weight of a light-emitting polymer [compound (XIV), polyfluorene compound, Mw≈10⁵] as a light-emitting material is spin coated to form a light-emitting layer having a charge-transporting ability and having a thickness of 110 nm.

### Comparative Example 7A

An organic electroluminescence device is prepared in the same manner as in Example 2A, except that, as a cathode, a 20 nm thickness of calcium (Ca) layer and a 150 nm thickness of aluminum layer are laminated in this order by deposition to form a back electrode having a width of 2 mm and a thickness of 0.15 μm so as to cross the ITO electrode.

### Comparative Example 8A

An organic electroluminescence device is prepared in the same manner as in Example 2A, except that, as a cathode, a 150 nm thickness of an alloy of silver (Ag) and magnesium (Mg) is formed by co-deposition to form a back electrode having a width of 2 mm and a thickness of 0.15 μm so as to cross the ITO electrode.

### Comparative Example 9A

An organic electroluminescence device is prepared in the same manner as in Example 2A, except that: a side chain type charge transporting polymer [compound (XVI)] (Mw=1.10×10⁵) as a hole-transporting material is spin coated on the washed and dried glass substrate with an ITO electrode at the ITO electrode side of the substrate to form a hole transport layer having a thickness of 30 nm; and after the hole transport layer is sufficiently dried, a light-emitting polymer [compound (XIV), polyfluorene compound, Mw≈10⁵] as a light-emitting material is spin coated on the hole transport layer to form a light-emitting layer having a thickness of 60 nm.

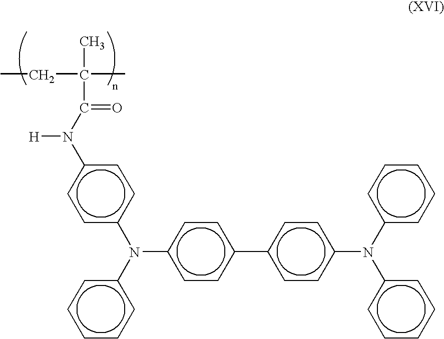

### Comparative Example 10A

An organic electroluminescence device is prepared in the same manner as in Example 2A, except that: a main chain type charge transporting polymer [compound (XVII)] (Mw=8.3×10⁴) as a hole-transporting material is spin coated on the washed and dried glass substrate with an ITO electrode at the ITO electrode side of the substrate to form a hole transport layer having a thickness of 15 nm; and after the hole transport layer is sufficiently dried, a light-emitting polymer [compound (XV), polyparaphenylenevinylene (PPV) compound, Mw≈10⁵] as a light-emitting material is spin coated on the hole transport layer to form a light-emitting layer having a thickness of 60 nm, and finally, as a cathode, a 20 nm thickness of calcium (Ca) layer and a 150 nm thickness of aluminum layer are laminated by deposition in this order to form a back electrode having a width of 2 mm and a thickness of 0.15 μm so as to cross the ITO electrode.

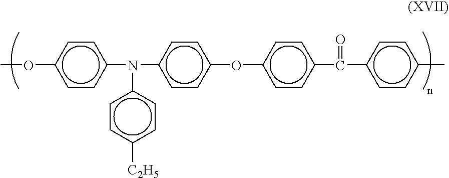

### Comparative Example 11A

An organic electroluminescence device is prepared in the same manner as in Example 2A, except that: a main chain type charge transporting polymer [compound (XVII)] (Mw=8.3×10⁴) as a hole-transporting material is spin coated on the washed and dried glass substrate with an ITO electrode at the ITO electrode side of the substrate to form a hole transport layer having a thickness of 15 nm; and after the hole transport layer is sufficiently dried, a light-emitting polymer [compound (XV), polyparaphenylenevinylene (PPV) compound, Mw≈10⁵] as a light-emitting material is spin coated on the hole transport layer to form a light-emitting layer having a thickness of 60 nm.

### (Evaluation)

In vacuum (1.33×10⁻¹ Pa), 5 V direct-current voltage is applied to each of the organic electroluminescence devices prepared as described above (the ITO electrode side is positive side and the back electrode side is the negative side), measurements of light emission are carried out, and a threshold voltage and a maximum brightness are evaluated. Obtained results are shown in Table 1.

Also, a light-emitting life of the organic electroluminescence device is measured in dry nitrogen. A current is selected so as to obtain an initial brightness of 100 cd/m² and a device life (hour) is defined as a time at which the brightness decreases to a half of the initial value under a constant-current drive. The driving current density at this time and the device life are shown in Table 1.

TABLE 1

| | threshold | maximum | | |
|---|---|---|---|---|
| | voltage | brightness | driving current | device life |
| | (V) | (cd/m²) | density (mA/cm²) | (hour) |
| Example 1A | 2.2 | 10,000 | 300 | 41 |
| Example 2A | 2.6 | 10,400 | 255 | 38 |
| Example 3A | 3.8 | 4,300 | 180 | 21 |
| Example 4A | 2.1 | 13,000 | 320 | 44 |
| Example 5A | 2.4 | 10,500 | 290 | 41 |
| Example 6A | 3.9 | 5,700 | 190 | 20 |
| Example 7A | 2.0 | 9,800 | 275 | 43 |
| Example 8A | 2.0 | 11,400 | 280 | 48 |
| Example 9A | 2.0 | 11,500 | 310 | 38 |
| Example 10A | 2.0 | 10,400 | 300 | 30 |
| Comp. Ex. 1A | 2.0 | 9,500 | 300 | 19 |
| Comp. Ex. 2A | 2.5 | 9,200 | 240 | 15 |
| Comp. Ex. 3A | 3.7 | 2,950 | 270 | 5 |
| Comp. Ex. 4A | 3.5 | 3,000 | 300 | 7 |
| Comp. Ex. 5A | 3.9 | 4,500 | 90 | 25 |
| Comp. Ex. 6A | 5.1 | 980 | 120 | 20 |
| Comp. Ex. 7A | 2.8 | 10,200 | 255 | 33 |
| Comp. Ex. 8A | 3.3 | 10,700 | 300 | 12 |
| Comp. Ex. 9A | 2.3 | 3,400 | 270 | 34 |
| Comp. Ex. 10A | 2.1 | 4,000 | 310 | 25 |
| Comp. Ex. 11A | 2.1 | 4,010 | 310 | 46 |

As apparent from Table 1, the organic electroluminescence devices obtained in Examples are improved in charge injecting property, charge transporting property and charge balance by selecting, in the appropriate range, the thickness of the layer that is nearest, of the layers containing the specific charge-transporting polyester, to the anode (the hole transport layer, the light-emitting layer having a charge-transporting ability); stabler and higher in brightness and efficiency in comparison with the organic electroluminescence devices of Comparative Examples 1A to 3A having too small thickness and Comparative Examples 4A to 6A having too large thickness; and superior in device life and light-emitting brightness.

As apparent from a comparison of Examples with Comparative Examples 9A to 11A, the organic electroluminescence devices in Examples have a sufficient brightness and are superior in stability and durability owing to the use of the specific charge-transporting polyester.

As apparent from a comparison of Examples with Comparative Examples 7A to 11A, the organic electroluminescence devices in Examples containing the specific charge-transporting polyester and having the specific cathode structure (back electrode structure) are far superior in device life and light-emitting brightness.

In addition, there are no pinholes or peeling defects at the film formation in any of Examples. Also, since satisfactory thin films can be formed by spin coating or dip coating at the preparation, these organic electroluminescence devices show few defects such as pinholes, and can be easily formed over a large area.

Therefore, the organic electroluminescence devices obtained in Examples have a sufficient brightness, are superior in stability and durability, can be formed over a large area and easily manufactured, and show few defects caused in the production and little deterioration in the device performance with time.

### <Examples According to the Second Aspect of the Invention>

### —Synthesis of Charge-Transporting Polyester—

### Synthesis Example 1B

2.0 g of a following compound (XI-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XI-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of tetrahydrofuran (THF). Then the insoluble substance is filtered off with a 0.2 μm polytetrafluoroethylene (PTFE) filter, and the filtrate is subjected to a reprecipitation by dripping into 500 ml of methanol under agitation, thereby precipitating a polymer. The obtained polymer is separated by filtration, washed sufficiently with methanol and dried to obtain 1.9 g of hole-transporting polyester (XI-2).

The hole-transporting polyester (XI-2), in a measurement of molecular weight distribution by gel permeation chromatography (GPC), shows a weight-average molecular weight Mw=7.24×10⁴ (converted as styrene), and a ratio (Mw/Mn) of a number-average molecular weight Mn and a weight-average molecular weight Mw of 1.87.

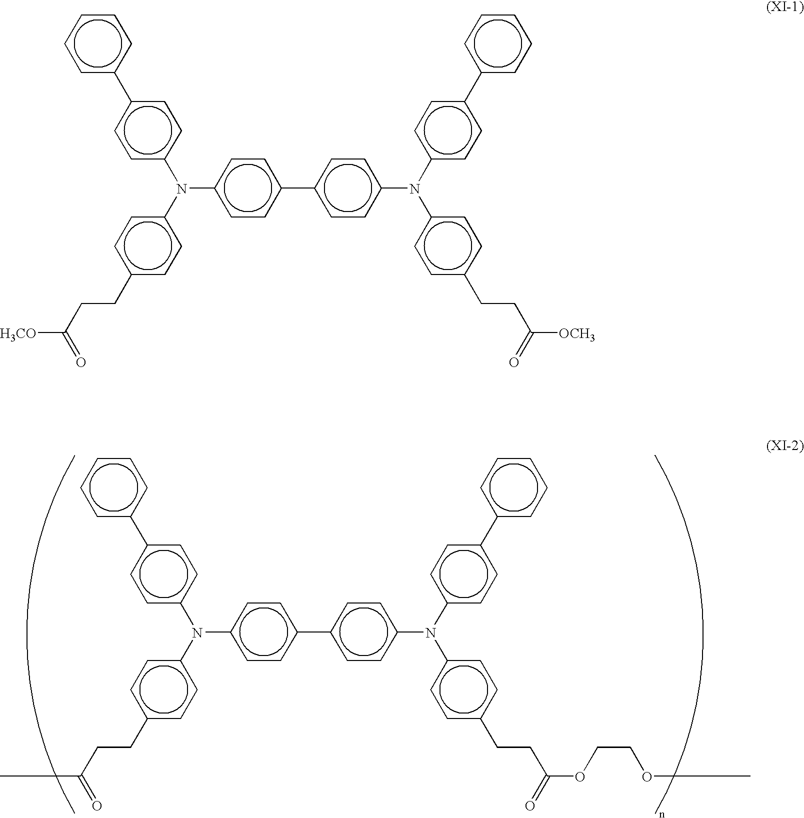

### Synthesis Example 2B

2.0 g of a following compound (XII-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XII-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of THF. Then the insoluble substance is filtered off with a 0.2 μm PTFE filter, and the filtrate is subjected to a reprecipitation by dripping into 500 ml of methanol under agitation, thereby precipitating a polymer. The obtained polymer is separated by filtration, washed sufficiently with methanol and dried to obtain 1.7 g of electron-transporting polyester (XII-2).

The electron-transporting polyester (XII-2), in a measurement of molecular weight distribution by gel permeation chromatography (GPC), shows Mw=1.08×10⁵ (converted as styrene), and Mw/Mn=2.31.

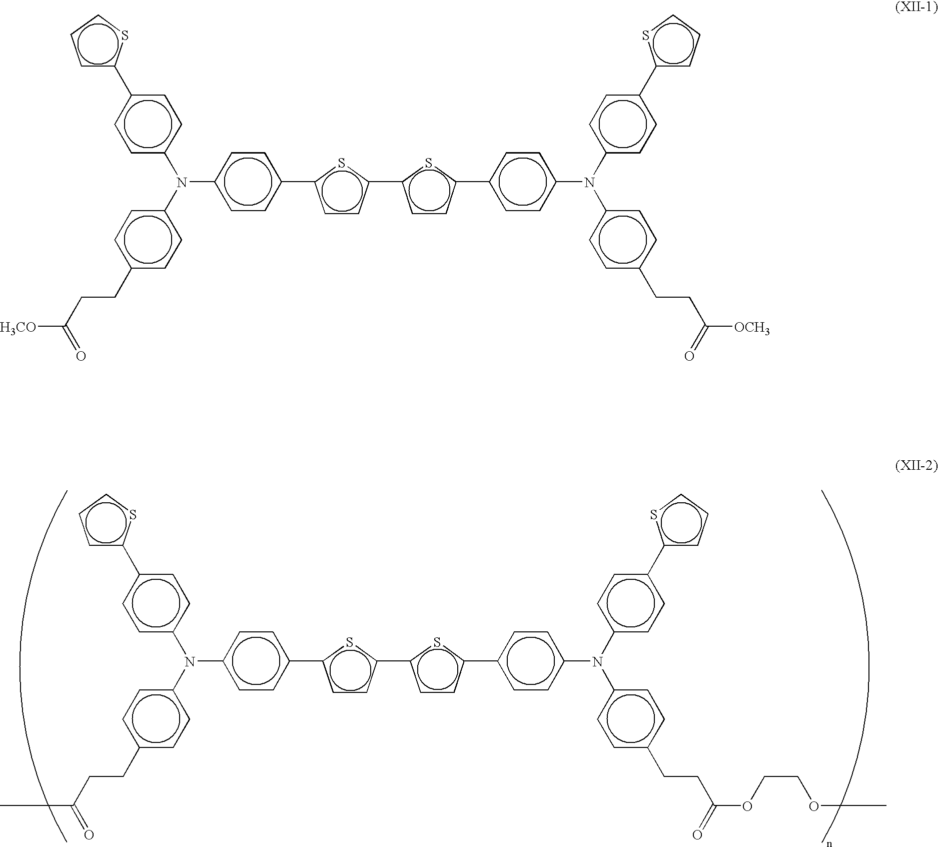

### Synthesis Example 3B

2.0 g of a following compound (XIII-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XIII-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of THF. Then the insoluble substance is filtered off with a 0.2 μm PTFE filter, and the filtrate is subjected to a reprecipitation by dripping into 500 ml of methanol under agitation, thereby precipitating a polymer. The obtained polymer is separated by filtration, washed sufficiently with methanol and dried to obtain 1.85 g of hole-transporting polyester (XIII-2).

The hole-transporting polyester (XIII-2), in a measurement of molecular weight distribution by gel permeation chromatography (GPC), shows Mw=7.08×10⁴ (converted as styrene), and Mw/Mn=2.00.

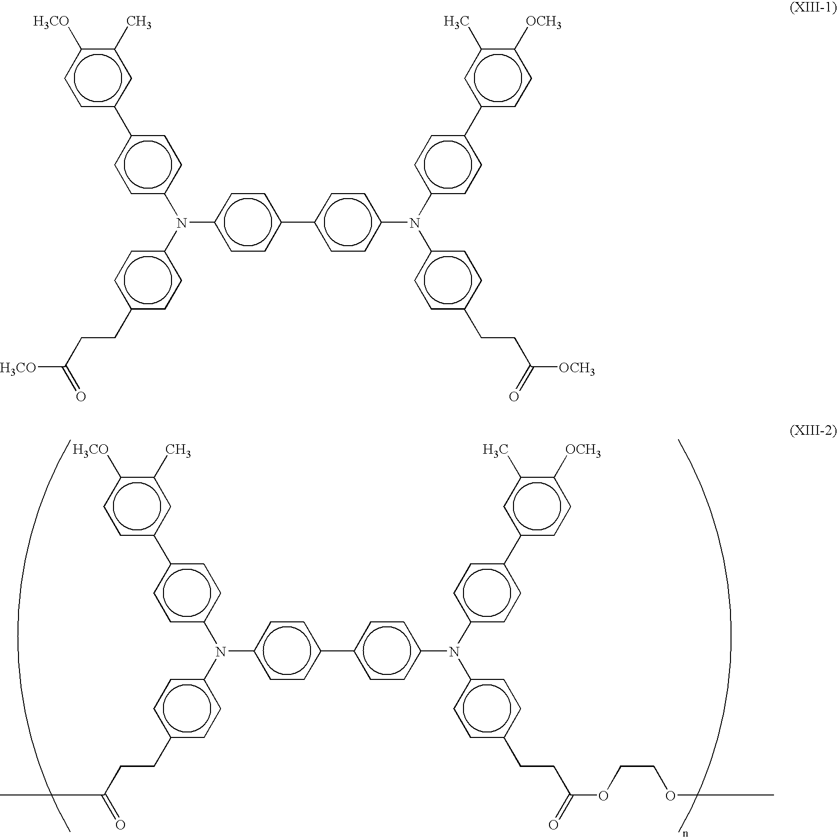

### Synthesis Example 4B

2.0 g of a following compound (XIV-1), 8.0 g of ethylene glycol and 0.1 g of tetrabutoxytitanium are charged in a 50-ml flask and are heated under agitation for 5 hours at 190° C. under a nitrogen flow.

After the consumption of the compound (XIV-1) is confirmed, the mixture is heated at 200° C. under a pressure reduced to 0.25 mmHg for distilling off ethylene glycol, and the reaction is continued for 5 hours. Thereafter, the mixture is cooled to the room temperature, and dissolved in 50 ml of THF. Then the insoluble substance is filtered off with a 0.2 μm PTFE filter, and the filtrate is subjected to a reprecipitation by dripping into 500 ml of methanol under agitation, thereby precipitating a polymer. The obtained polymer is separated by filtration, washed sufficiently with methanol and dried to obtain 1.9 g of hole-transporting polyester (XIV-2).

The hole-transporting polyester (XIV-2), in a measurement of molecular weight distribution by gel permeation chromatography (GPC), shows Mw=1.12×10⁵ (converted as styrene), and Mw/Mn=1.71.

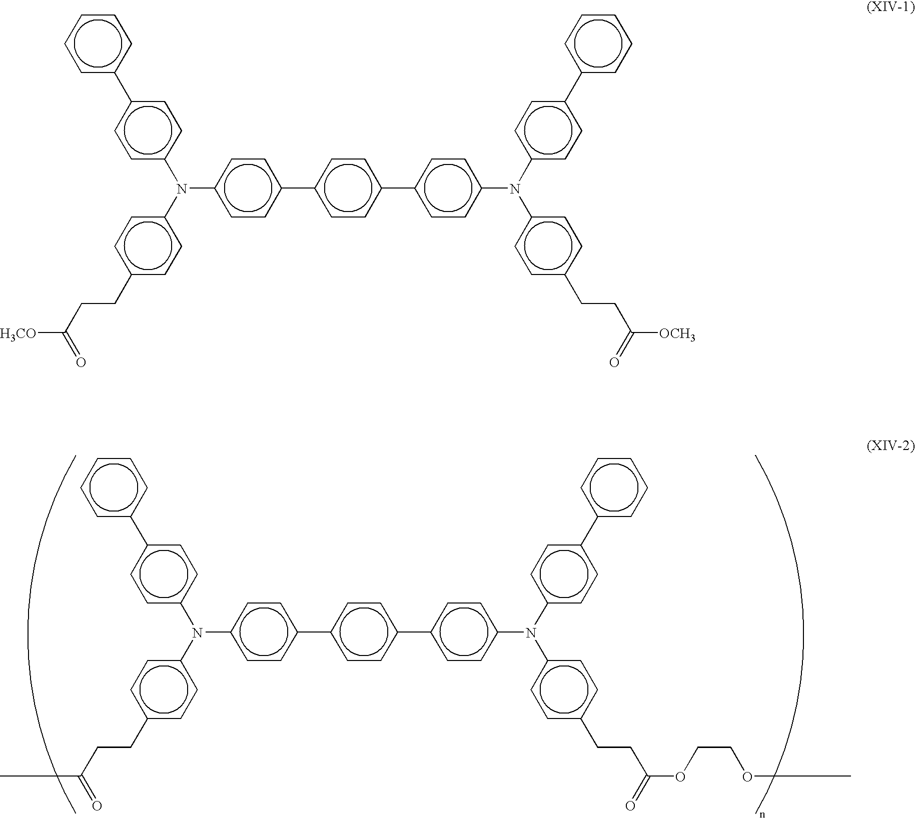

### —Preparation of Organic Electroluminescence Device—

Then an organic electroluminescence device is prepared in the following manner, utilizing thus synthesized charge-transporting polyester.

### Example 1B

As a solution for forming a buffer layer, Baytron P (manufactured by Bayer AG; a mixed aqueous dispersion containing polyethylene dioxide thiophene [compound (II), ionization potential=5.1-5.2 eV] and polystyrene sulfonic acid) is used, which is filtered with a polytetrafluoroethylene (PTFE) filter having a mesh size of 0.5 μm.

Also, a substrate on which a rectangular ITO electrode having a width of 2 mm is formed by etching is prepared as a substrate with a transparent electrode (hereinafter called a “glass substrate with an ITO electrode”).

Then this solution is spin coated on the washed and dried glass substrate with an ITO electrode at the ITO electrode side of the substrate to form a buffer layer having a thickness of 20 nm. After the buffer layer is sufficiently dried, a chlorobenzene solution containing 1 wt. % of a charge-transporting polyester [compound (XI-2)] (Mw=7.24×10⁴) as a hole-transporting material is filtered with a polytetrafluoroethylene (PTFE) filter having a mesh size of 0.1 μm, and spin coated on the buffer layer to form a hole transport layer having a thickness of 30 nm. After the hole transport layer is sufficiently dried, a xylene solution containing 1 wt. % of a light-emitting polymer [following compound (XV), polyfluorene compound, Mw≈10⁵] as a light-emitting material is filtered with a polytetrafluoroethylene (PTFE) filter having a mesh size of 0.1 μm, and spin coated on the hole transport layer to form a light-emitting layer having a thickness of 60 nm.

After the formed light-emitting layer is sufficiently dried, a chlorobenzene solution containing 2 wt. % of a charge-transporting polyester [compound (XII-2)] (Mw=1.08×10⁵) as an electron-transporting material is filtered with a PTFE filter having a mesh size of 0.1 μm, and is spin coated on the light-emitting layer to form an electron transport layer having a thickness of 30 nm. Finally, as a cathode, a 1 nm thickness of lithium fluoride (LiF) layer (first layer), a 20 nm thickness of calcium (Ca) layer (second layer) and a 150 nm thickness of aluminum layer (third layer) are laminated in this order by deposition to form a back electrode having a width of 2 mm and a thickness of 0.15 μm so as to cross the ITO electrode. The formed organic electroluminescence device has an effective area of 0.04 cm².

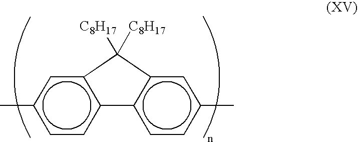

### Example 2B

As a solution for forming a buffer layer, Baytron P (manufactured by Bayer AG; a mixed aqueous dispersion containing polyethylene dioxide thiophene [compound (II), ionization potential=5.1-5.2 eV] and polystyrene sulfonic acid) is used, which is filtered with a polytetrafluoroethylene (PTFE) filter having a mesh size of 0.5 μm.

Then this solution is spin coated on the washed and dried glass substrate with an ITO electrode at the ITO electrode side of the substrate to form a buffer layer having a thickness of 20 nm. After the buffer layer is sufficiently dried, a chlorobenzene solution containing 1 wt. % of a charge-transporting polyester [compound (XI-2)] (Mw=7.24×10⁴) as a hole-transporting material is filtered with a polytetrafluoroethylene (PTFE) filter having a mesh size of 0.1 μm, and spin coated on the buffer layer to form a hole transport layer having a thickness of 30 nm. After the hole transport layer is sufficiently dried, a xylene solution containing 1 wt. % of a light-emitting polymer [compound (XV), polyfluorene compound, Mw≈10⁵] as a light-emitting material is filtered with a polytetrafluoroethylene (PTFE) filter having a mesh size of 0.1 μm, and spin coated on the hole transport layer to form a light-emitting layer having a thickness of 60 nm.

After the formed light-emitting layer is sufficiently dried, finally, as a cathode, a 1 nm thickness of lithium fluoride (LiF) layer (first layer), a 20 nm thickness of calcium (Ca) layer (second layer) and a 150 nm thickness of aluminum layer (third layer) are laminated in this order by deposition to form a back electrode having a width of 2 mm and a thickness of 0.15 μm so as to cross the ITO electrode. The formed organic electroluminescence device has an effective area of 0.04 cm².

### Example 3B

As a solution for forming a buffer layer, Baytron P (manufactured by Bayer AG; a mixed aqueous dispersion containing polyethylene dioxide thiophene [compound (II), ionization potential=5.1-5.2 eV] and polystyrene sulfonic acid) is used, which is filtered with a polytetrafluoroethylene (PTFE) filter having a mesh size of 0.5 μm.

Then this solution is spin coated on the washed and dried glass substrate with an ITO electrode at the ITO electrode side of the substrate to form a buffer layer having a thickness of 20 nm. After the buffer layer is sufficiently dried, a xylene solution containing 5 wt. % of a mixture prepared by mixing 0.5 parts by weight of a charge-transporting polyester [compound (XI-2)] (Mw=7.24×10⁴) as a hole-transporting material and 0.1 part by weight of a light-emitting polymer [compound (XV), polyfluorene compound, Mw≈10⁵] as a light-emitting material is filtered with a polytetrafluoroethylene (PTFE) filter having a mesh size of 0.1 μm, and spin coated on the buffer layer to form a light-emitting layer having a charge-transporting ability and having a thickness of 50 nm.

After the formed light-emitting layer having a charge-transporting ability is sufficiently dried, finally, as a cathode, a 1 nm thickness of lithium fluoride (LiF) layer (first layer), a 20 nm thickness of calcium (Ca) layer (second layer) and a 150 nm thickness of aluminum layer (third layer) are laminated in this order by deposition to form a back electrode having a width of 2 mm and a thickness of 0.15 μm so as to cross the ITO electrode. The formed organic electroluminescence device has an effective area of 0.04 cm².

### Example 4B

An organic electroluminescence device is prepared in the same manner as in Example 1B, except that a light-emitting polymer [following compound (XVI), polyparaphenylenevinylene (PPV) compound, Mw≈10⁵] as a light-emitting material is spin coated to form a light-emitting layer having a thickness of 60 nm.

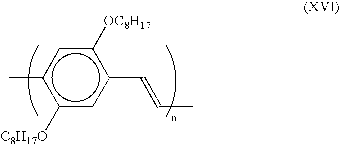

### Example 5B

An organic electroluminescence device is prepared in the same manner as in Example 2B, except that a light-emitting polymer [compound (XVI), polyparaphenylenevinylene (PPV) compound, Mw≈10⁵] as a light-emitting material is spin coated to form a light-emitting layer having a thickness of 60 nm.

### Example 6B

An organic electroluminescence device is prepared in the same manner as in Example 3B, except that 0.1 part by weight of a light-emitting polymer [compound (XVI), polyparaphenylenevinylene (PPV) compound, Mw≈10⁵] as a light-emitting material is mixed to form a light-emitting layer having a thickness of 50 nm.

### Example 7B

An organic electroluminescence device is prepared in the same manner as in Example 2B, except that a charge-transporting polyester [compound (XIII-2)] (Mw=7.08×10⁴) as a hole-transporting material is spin coated to form a hole transport layer having a thickness of 30 nm.

### Example 8B

An organic electroluminescence device is prepared in the same manner as in Example 5B, except that a charge-transporting polyester [compound (XIII-2)] (Mw=7.08×10⁴) as a hole-transporting material is spin coated to form a hole transport layer having a thickness of 30 nm.

### Example 9B

An organic electroluminescence device is prepared in the same manner as in Example 2B, except that a charge-transporting polyester [compound (XIV-2)] (Mw=1.12×10⁵) as a hole-transporting material is spin coated to form a hole transport layer having a thickness of 30 nm.

### Example 10B

An organic electroluminescence device is prepared in the same manner as in Example 5B, except that a charge-transporting polyester [compound (XIV-2)] (Mw=1.12×10⁵) as a hole-transporting material is spin coated to form a hole transport layer having a thickness of 30 nm.

### Comparative Example 1B

An organic electroluminescence device is prepared in the same manner as in Example 2B, except that a charge-transporting polyester [compound (XI-2)] (Mw=7.24×10⁴) as a hole-transporting material is spin coated to form a hole transport layer having a thickness of 15 nm.

### Comparative Example 2B

An organic electroluminescence device is prepared in the same manner as in Example 5B, except that a charge-transporting polyester [compound (XI-2)] (Mw=7.24×10⁴) as a hole-transporting material is spin coated to form a hole transport layer having a thickness of 15 nm.

### Comparative Example 3B

An organic electroluminescence device is prepared in the same manner as in Example 3B, except that a chlorobenzene solution containing a mixture prepared by mixing 0.5 parts by weight of a charge-transporting polyester [compound (XI-2)] (Mw=7.24×10⁴) as a hole-transporting material and 0.1 part by weight of a light-emitting polymer [compound (XV), polyfluorene compound, Mw≈10⁵] as a light-emitting material is spin coated to form a light-emitting layer having a charge-transporting ability and having a thickness of 15 nm.

### Comparative Example 4B

An organic electroluminescence device is prepared in the same manner as in Example 2B, except that a charge-transporting polyester [compound (XI-2)] (Mw=7.24×10⁴) as a hole-transporting material is spin coated to form a hole transport layer having a thickness of 110 nm.

### Comparative Example 5B

An organic electroluminescence device is prepared in the same manner as in Example 5B, except that a charge-transporting polyester [compound (XI-2)] (Mw=7.24×10⁴) as a hole-transporting material is spin coated to form a hole transport layer having a thickness of 110 nm.

### Comparative Example 6B

An organic electroluminescence device is prepared in the same manner as in Example 3B, except that a chlorobenzene solution containing a mixture prepared by mixing 0.5 parts by weight of a charge-transporting polyester [compound (XI-2)] (Mw=7.24×10⁴) as a hole-transporting material and 0.1 part by weight of a light-emitting polymer [compound (XVI), polyparaphenylenevinylene (PPV) compound, Mw≈10⁵] as a light-emitting material is spin coated to form a light-emitting layer having a charge-transporting ability and having a thickness of 110 nm.

### Comparative Example 7B

An organic electroluminescence device is prepared in the same manner as in Example 2B, except that, as a cathode, a 20 nm thickness of calcium (Ca) layer and a 150 nm thickness of aluminum layer are laminated in this order by deposition to form a back electrode having a width of 2 mm and a thickness of 0.15 μm so as to cross the ITO electrode.

### Comparative Example 8B

An organic electroluminescence device is prepared in the same manner as in Example 2B, except that, as a cathode, a 150 nm thickness of an alloy of silver (Ag) and magnesium (Mg) is formed by co-deposition to form a back electrode having a width of 2 mm and a thickness of 0.15 μm so as to cross the ITO electrode.

### Comparative Example 9B

An organic electroluminescence device is prepared in the same manner as in Example 2B, except that: as a solution for forming a buffer layer, Baytron P is used and spin coated on the washed and dried glass substrate with an ITO electrode at the ITO electrode side of the substrate to form a buffer layer having a thickness of 250 nm; after the buffer layer is sufficiently dried, a charge-transporting polyester [compound (XI-2)] (Mw=7.24×10⁴) as a hole-transporting material is spin coated on the buffer layer to form a hole transport layer having a thickness of 30 nm; and after the hole transport layer is sufficiently dried, a light-emitting polymer [compound (XV), polyfluorene compound, Mw≈10⁵] as a light-emitting material is spin coated on the hole transport layer to form a light-emitting layer having a thickness of 60 mm.

### Comparative Example 10B

An organic electroluminescence device is prepared in the same manner as in Example 2B, except that: as a solution for forming a buffer layer, Baytron P is used and spin coated on the washed and dried glass substrate with an ITO electrode at the ITO electrode side of the substrate to form a buffer layer having a thickness of 20 nm; after the buffer layer is sufficiently dried, a charge-transporting polyester [compound (XI-2)] (Mw=7.24×10⁴) as a hole-transporting material is spin coated on the buffer layer to form a hole transport layer having a thickness of 15 nm; and after the hole transport layer is sufficiently dried, a light-emitting polymer [compound (XVI), polyparaphenylenevinylene (PPV) compound, Mw≈10⁵] as a light-emitting material is spin coated on the hole transport layer to form a light-emitting layer having a thickness of 60 nm.

### Comparative Example 11B

An organic electroluminescence device is prepared in the same manner as in Example 2B, except that: as a solution for forming a buffer layer, Baytron P is used and spin coated on the washed and dried glass substrate with an ITO electrode at the ITO electrode side of the substrate to form a buffer layer having a thickness of 20 nm; after the buffer layer is sufficiently dried, a side chain type charge transporting polymer [compound (XVII)] (Mw=1.10×10⁵) as a hole-transporting material is spin coated on the buffer layer to form a hole transport layer having a thickness of 30 nm; and after the hole transport layer is sufficiently dried, a light-emitting polymer [compound (XV), polyfluorene compound, Mw≈10⁵] as a light-emitting material is spin coated on the hole transport layer to form a light-emitting layer having a thickness of 60 mm.

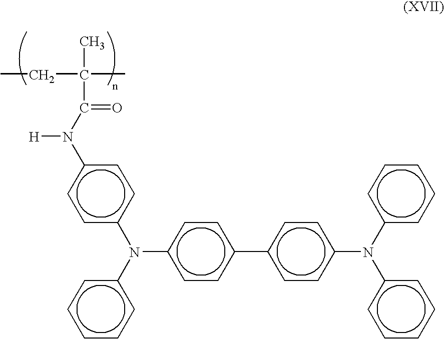

### Comparative Example 12B

An organic electroluminescence device is prepared in the same manner as in Example 2B, except that: as a solution for forming a buffer layer, Baytron P is used and spin coated on the washed and dried glass substrate with an ITO electrode at the ITO electrode side of the substrate to form a buffer layer having a thickness of 20 nm; after the buffer layer is sufficiently dried, a main chain type charge transporting polymer [compound (XVIII)] (Mw=8.3×10⁴) as a hole-transporting material is spin coated on the buffer layer to form a hole transport layer having a thickness of 15 nm; and after the hole transport layer is sufficiently dried, a light-emitting polymer [compound (XVI), polyparaphenylenevinylene (PPV) compound, Mw≈10⁵] as a light-emitting material is spin coated on the hole transport layer to form a light-emitting layer having a thickness of 60 nm, and finally, as a cathode, a 20 nm thickness of calcium (Ca) layer and a 150 nm thickness of aluminum layer are laminated by deposition in this order to form a back electrode having a width of 2 mm and a thickness of 0.15 μm so as to cross the ITO electrode.

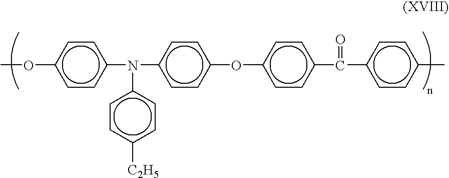

### Comparative Example 13B

An organic electroluminescence device is prepared in the same manner as in Example 2B, except that: as a solution for forming a buffer layer, Baytron P is used and spin coated on the washed and dried glass substrate with an ITO electrode at the ITO electrode side of the substrate to form a buffer layer having a thickness of 50 nm; after the buffer layer is sufficiently dried, a main chain type charge transporting polymer [compound (XVIII)] (Mw=8.3×10⁴) as a hole-transporting material is spin coated on the buffer layer to form a hole transport layer having a thickness of 15 nm; and after the hole transport layer is sufficiently dried, a light-emitting polymer [compound (XVI), polyparaphenylenevinylene (PPV) compound, Mw≈10⁵] as a light-emitting material is spin coated on the hole transport layer to form a light-emitting layer having a thickness of 60 nm.

### (Evaluation)

In vacuum (1.33×10⁻¹ Pa), 5 V direct-current voltage is applied to each of the organic electroluminescence devices prepared as described above (the ITO electrode side is positive side and the back electrode side is the negative side), measurements of light emission are carried out, and a threshold voltage and a maximum brightness are evaluated. Obtained results are shown in Table 2.

Also, a light-emitting life of the organic electroluminescence device is measured in dry nitrogen. A current is selected so as to obtain an initial brightness of 100 cd/m² and a device life (hour) is defined as a time at which the brightness decreases to a half of the initial value under a constant-current drive. The driving current density at this time and the device life are shown in Table 2.

TABLE 2

| | threshold | maximum | | |
|---|---|---|---|---|
| | voltage | brightness | driving current | device life |
| | (V) | (cd/m²) | density (mA/cm²) | (hour) |
| Example 1B | 2.2 | 11,000 | 310 | 60 |
| Example 2B | 2.5 | 10,300 | 255 | 51 |
| Example 3B | 3.7 | 5,630 | 170 | 39 |
| Example 4B | 2.1 | 15,000 | 330 | 64 |
| Example 5B | 2.4 | 11,500 | 280 | 55 |
| Example 6B | 3.7 | 6,400 | 180 | 45 |
| Example 7B | 1.9 | 10,500 | 280 | 43 |
| Example 8B | 2.0 | 11,400 | 290 | 48 |
| Example 9B | 1.9 | 11,500 | 300 | 58 |
| Example 10B | 2.0 | 13,400 | 320 | 60 |
| Comp. Ex. 1B | 2.0 | 10,900 | 300 | 29 |
| Comp. Ex. 2B | 2.5 | 10,200 | 240 | 21 |
| Comp. Ex. 3B | 3.7 | 3,630 | 270 | 15 |
| Comp. Ex. 4B | 3.5 | 4,000 | 300 | 19 |
| Comp. Ex. 5B | 3.8 | 5,600 | 80 | 25 |
| Comp. Ex. 6B | 5.0 | 1,020 | 210 | 39 |
| Comp. Ex. 7B | 2.4 | 10,200 | 255 | 40 |
| Comp. Ex. 8B | 3.3 | 10,700 | 300 | 18 |
| Comp. Ex. 9B | 2.3 | 10,400 | 255 | 40 |
| Comp. Ex. 10B | 2.1 | 10,000 | 300 | 30 |
| Comp. Ex. 11B | 2.3 | 3,400 | 270 | 34 |
| Comp. Ex. 12B | 2.1 | 4,000 | 310 | 25 |
| Comp. Ex. 13B | 2.1 | 4,010 | 310 | 46 |

As apparent from Table 2, the organic electroluminescence devices in Examples are improved in charge injecting property and charge balance by forming a buffer layer containing the specific charge-injecting material in contact with the anode (ITO electrode); improved in charge injecting property, charge transporting property and charge balance by selecting, in the appropriate range, the thickness of the layer that is nearest, of the layers containing the specific charge-transporting polyester, to the anode (the hole transport layer, the light-emitting layer having a charge-transporting ability); stabler and higher in brightness and efficiency in comparison with the organic electroluminescence devices of Comparative Examples 1B to 3B having too small thickness and Comparative Examples 4B to 6B having too large thickness; and superior in device life and light-emitting brightness.

As apparent from a comparison of Examples with Comparative Examples 11B to 13B, the organic electroluminescence devices in Examples have a sufficient brightness and are superior in stability and durability owing to the use of the specific charge-transporting polyester.

As apparent from a comparison of Examples with Comparative Examples 7B to 8B and 11B to 13B, the organic electroluminescence devices in Examples containing the specific charge-transporting polyester and having the specific cathode structure (back electrode structure) are far superior in device life and light-emitting brightness.

As apparent from a comparison of Examples with Comparative Examples 9B and 8B, the organic electroluminescence devices in Examples, in which each of the thickness of the hole transport layer and the thickness of the buffer layer is in the appropriate range, are superior in device life and light-emitting brightness.

In addition, there are no pinholes or peeling defects at the film formation in any of Examples. Also, since satisfactory thin films can be formed by spin coating or dip coating at the preparation, these organic electroluminescence devices show few defects such as pinholes, and can be easily formed in a large area.

Therefore, the organic electroluminescence devices obtained in Examples have a sufficient brightness, are superior in stability and durability, can be formed in a large area and easily manufactured, and show few defects caused in the production and little deterioration in the device performance with time.

What is claimed is:

1. An organic electroluminescence device comprising: an anode; a cathode; and
an organic compound layer, sandwiched between the anode and the cathode;
at least one of the anode or the cathode being transparent or semi-transparent;
the organic compound layer including one or more layers including at least a light-emitting layer;
the organic compound layer including at least one layer including at least one charge-transporting polyester;
the charge-transporting polyester including repeating units each containing, as a partial structure, one or more structures each represented by the following formula (I-1) or (I-2): 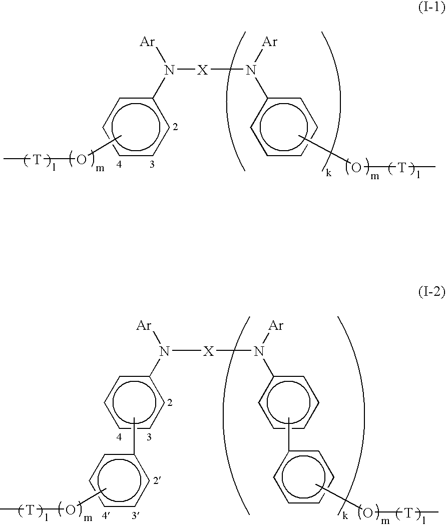
in the formulas (I-1) and (I-2), Ar representing a substituted or unsubstituted monovalent aromatic group, X representing a substituted or unsubstituted divalent aromatic group, k, m and l each representing 0 or 1, and T representing a linear divalent hydrocarbon having 1 to 6 carbon atoms or a branched hydrocarbon having 2 to 10 carbon atoms;
the thickness being about 20 to 100 nm of the nearest layer to the anode of the at least one layer including at least one charge-transporting polyester;
the cathode comprising a first layer and a second layer;
the first layer being in contact with the organic compound layer and comprising at least one selected from the group consisting of alkaline metal oxides, alkaline earth metal oxides, alkaline metal halides and alkaline earth metal halides;
the second layer being in contact with the first layer and comprising at least one selected from the group consisting of alkaline metals and alkaline earth metals.

2. The organic electroluminescence device according to claim 1, wherein the organic compound layer is formed by laminating at least a hole transport layer, the light-emitting layer and an electron transport layer in this order from the anode side, and at least the hole transport layer, of the hole transport layer and the electron transport layer, includes the at least one charge-transporting polyester.

3. The organic electroluminescence device according to claim 2, wherein the light-emitting layer includes a charge-transporting material other than the charge-transporting polyester.

4. The organic electroluminescence device according to claim 2, wherein the hole transport layer has a thickness of about 20 to 100 nm.

5. The organic electroluminescence device according to claim 1, wherein the organic compound layer is formed by laminating at least a hole transport layer and the light-emitting layer in this order from the anode side, and at least the hole transport layer, of the hole transport layer and the light-emitting layer, includes the at least one charge-transporting polyester.

6. The organic electroluminescence device according to claim 5, wherein the light-emitting layer includes a charge-transporting material other than the charge-transporting polyester.

7. The organic electroluminescence device according to claim 5, wherein the hole transport layer has a thickness of about 20 to 100 nm.

8. The organic electroluminescence device according to claim 1, wherein the organic compound layer is formed by at least a light-emitting layer having a charge-transporting ability, and the light-emitting layer having a charge-transporting ability includes the at least one charge-transporting polyester.

9. The organic electroluminescence device according to claim 8, wherein the light-emitting layer having a charge-transporting ability has a thickness of about 20 to 100 nm.

10. The organic electroluminescence device according to claim 1, wherein the cathode is formed by laminating the first layer, the second layer and a third layer in this order from the organic compound layer side, and wherein the third layer is in contact with the second layer and includes aluminum.

11. The organic electroluminescence device according to claim 1, wherein the charge-transporting polyester is represented by the following formula (II-1) or (II-2): 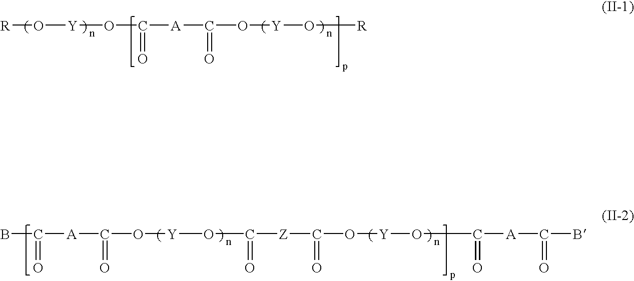
wherein, in the formulas (II-1) and (II-2), A represents one or more structures each represented by the formula (I-1) or (I-2); R represents a hydrogen atom, an alkyl group, a substituted or unsubstituted aryl group or a substituted or unsubstituted aralkyl group; Y represents a divalent alcohol residue; Z represents a divalent carboxylic acid residue; B and B′ each independently represent —O—(Y—O)ₙ—R or —O—(Y—O)ₙ—CO-Z-CO—O—R′ (in which R, Y and Z have the same meanings as above; R′ represents an alkyl group, a substituted or unsubstituted aryl group or a substituted or unsubstituted aralkyl group; and n represents an integer of 1 through 5); n represents an integer of 1 through 5; and p represents an integer of 5 through 5,000.

12. An organic electroluminescence device comprising: an anode; a cathode; and
an organic compound layer, sandwiched between the anode and the cathode;
at least one of the anode or the cathode being transparent or semi-transparent;
the organic compound layer including two or more layers including at least a light-emitting layer and a buffer layer;
the organic compound layer including at least one layer containing at least one charge-transporting polyester;
the charge-transporting polyester including repeating units each containing, as a partial structure, one or more structures each represented by the following formula (I-1) or (I-2): 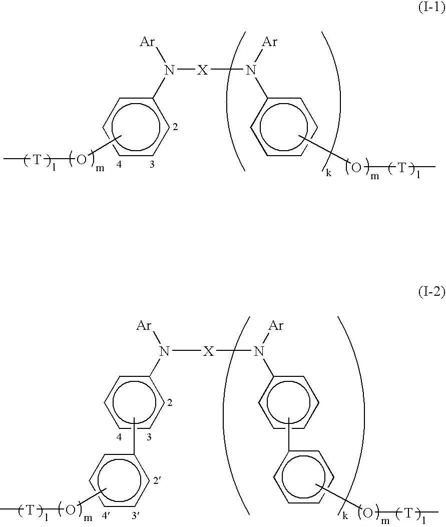
in the formulas (I-1) and (I-2), Ar representing a substituted or unsubstituted monovalent aromatic group, X representing a substituted or unsubstituted divalent aromatic group, k, m and l each representing 0 or 1, and T representing a linear divalent hydrocarbon having 1 to 6 carbon atoms or a branched hydrocarbon having 2 to 10 carbon atoms;
the thickness being about 20 to 100 nm of the nearest layer to the anode of the at least one layer including at least one charge-transporting polyester;
the cathode comprising a first layer and a second layer;
the first layer being in contact with the organic compound layer and comprising at least one selected from the group consisting of alkaline metal oxides, alkaline earth metal oxides, alkaline metal halides and alkaline earth metal halides;
the second layer being in contact with the first layer and comprising at least one selected from the group consisting of alkaline metals and alkaline earth metals;
the buffer layer being provided in contact with the anode and including one or more charge-injecting materials;
at least one of the charge injecting materials being a charge-transporting polymer including a structural unit represented by the following formula (II): 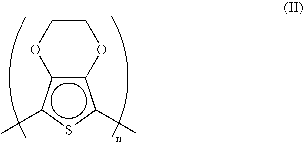
in the formula (II), n representing an integer of from 100 to 10,000.

13. The organic electroluminescence device according to claim 12, wherein the organic compound layer is formed by laminating at least the buffer layer, a hole transport layer, the light-emitting layer and an electron transport layer in this order from the anode side, and at least the hole transport layer, of the hole transport layer and the electron transport layer, includes the at least one charge-transporting polyester.

14. The organic electroluminescence device according to claim 13, wherein the light-emitting layer includes a charge-transporting material other than the charge-transporting polyester.

15. The organic electroluminescence device according to claim 13, wherein the hole transport layer has a thickness of about 20 to 100 nm.

16. The organic electroluminescence device according to claim 12, wherein the organic compound layer is formed by laminating at least the buffer layer, a hole transport layer and the light-emitting layer in this order from the anode side, and at least the hole transport layer, of the hole transport layer and the light-emitting layer, includes the at least one charge-transporting polyester.

17. The organic electroluminescence device according to claim 16, wherein the light-emitting layer contains a charge-transporting material other than the charge-transporting polyester.

18. The organic electroluminescence device according to claim 16, wherein the hole transport layer has a thickness of about 20 to 100 nm.

19. The organic electroluminescence device according to claim 12, wherein the organic compound layer is formed by laminating the buffer layer and a light-emitting layer having a charge-transporting ability in this order, and the light-emitting layer having a charge-transporting ability contains the at least one charge-transporting polyester.

20. The organic electroluminescence device according to claim 19, wherein the light-emitting layer having a charge-transporting ability has a thickness of about 20 to 100 nm.

21. The organic electroluminescence device according to claim 12, wherein the cathode is formed by laminating the first layer, the second layer and a third layer in this order from the organic compound layer side, and wherein the third layer is in contact with the second layer and includes aluminum.

22. The organic electroluminescence device according to claim 12, wherein the buffer layer has a thickness of about 1 to 200 nm.

23. The organic electroluminescence device according to claim 12, wherein the charge-transporting polyester is represented by the following formula (II-1) or (II-2): 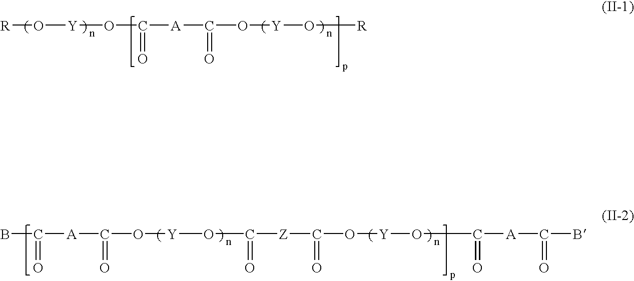
wherein, in the formulas (II-1) and (II-2), A represents one or more structures each represented by the formula (I-1) or (I-2); R represents a hydrogen atom, an alkyl group, a substituted or unsubstituted aryl group or a substituted or unsubstituted aralkyl group; Y represents a divalent alcohol residue; Z represents a divalent carboxylic acid residue; B and B′ each independently represent —O—(Y—O)ₙ—R or —O—(Y—O)ₙ—CO-Z-CO—O—R′ (in which R, Y and Z have the same meanings as above; R′ represents an alkyl group, a substituted or unsubstituted aryl group or a substituted or unsubstituted aralkyl group; and n represents an integer of 1 through 5); n represents an integer of 1 through 5; and p represents an integer of 5 through 5,000.
